(19) United States
(12) Patent Application Publication
(10) Pub. No.: US 2007/0106712 A1
(43) Pub. Date: May 10, 2007

(54) Replication arbitration apparatus, method and program

(75) Inventors: Junichi Yamato, Tokyo (JP); Masaki Kan, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/588,580

(22) Filed: Oct. 27, 2006

(30) Foreign Application Priority Data
Nov. 4, 2005 (JP) 2005-321128

(51) Int. Cl. G06F 17/30

(52) U.S. Cl. 707/204

(57) ABSTRACT

Replication between master storage and replica storage is performed via an arbitration apparatus. The arbitration apparatus controls transmission of update information from the master storage to the replica storage to thereby rationalize the updating sequence of replica storage.

### FIELD OF THE INVENTION

This invention relates to an information processing system that performs replication. More particularly, the invention relates to a system, method and program for rationalizing the updating sequence of a replica volume.

### BACKGROUND OF THE INVENTION

Computer systems equipped with a normal channel (or “active channel”) site and a standby channel site in order that operation will continue even in the event of a disaster or the like have long been used. Such a computer system is referred to as a “replication system”. By way of example, usually the normal-channel site operates to provide a system function. When the normal-channel site cannot function normally, the standby-channel site operates instead of the normal-channel site.

In order to provide the functions of a computer system, the normal site and the standby site each have storage for storing data.

A replication system is such that the data in the storage of the normal site is duplicated and held in the storage of the standby site in such a manner that the standby site can operate instead of the normal site (e.g., see Non-Patent Documents 1 and 2). This processing is referred to as “replication”.

In replication systems, there are cases where the normal site and standby site are “synchronous” (this shall be referred to as “synchronous replication” below) and cases where these sites are “asynchronous” (this shall be referred to as “asynchronous replication” below).

Synchronous replication is such that when data is written to storage of the normal site, this is taken as a trigger to write the same data to storage of the standby site.

On the other hand, asynchronous replication is such that writing of data to storage of the normal site is not taken as a trigger for writing of data to the standby site but after the fact writing of data to storage of the standby site is performed (therefore asynchronously).

In a storage system composed of a plurality of storages, there are cases where use is made of virtualizing technology in which the entire system is made to appear as single storage.

Further, a file system is a system that virtualizes storage as a plurality of units called files. How a file has been assigned to storage is managed in the file system layer. In a case where storage is a block-based apparatus, units files cannot be handled.

In a case where a normal site has suffered disaster, the standby site recovers the data in storage (referred to as “replica storage” below) of the standby site, which is a copy of the content of storage (referred to as “master storage”) of the normal site, and resumes operation.

With recovery of data performed at the standby site, it is possible to achieve data recovery in the following cases: a case where master storage and replica storage are perfectly synchronized; and

a case where data at a certain time in master storage is being sent asynchronously.

However, recovery of data in replica storage cannot be performed in a case where master storage and replica storage become desynchronized.

In a journal file system such as a database system or linux ext, reiser FS or xfs, recovery of data is possible in a case where a file/volume/block containing a journal log is in a condition newer than that of a file/volume/block containing other data.

An example of a disk subsystem that assures the sequential nature of data updating and the coherency of data over multiple disk subsystems and that has an asynchronous remote copy function is disclosed in Patent Document 1. The disclosed disk subsystem includes a main center and a remote center each of which has a host computer, a plurality of disk subsystems and a gateway subsystem. Duplexing of data is performed by synchronous remote copying between a remote-copy target volume of a disk subsystem and any volume of the gateway subsystem in each of the centers. The gateway subsystem of the main center transmits updated data to the gateway subsystem of the remote center in accordance with the order in which the volume in its own subsystem was updated. The gateway subsystem of the remote center performs duplexing of data by asynchronous remote copying, in which the updated data is reflected in the volume in its own subsystem, in accordance with the order in which the data was accepted. The gateway subsystem of the main center in the system disclosed in Patent Document 1 is such that if the host issues a write request to a disk subsystem, the data is written also to a buffer memory within its own disk subsystem in sync with issuance of the request, and a command to write the data is sent to the remote gateway subsystem asynchronously. Viewed macroscopically, the system disclosed in Patent Document 1 keeps the volumes of the disk subsystems of the main and remote centers the same at all times by transferring data while maintaining the order in which updating was performed. However, there are structural limitations, such as the placing of the gateway subsystems in opposition to each other, and there is also a limitation upon asynchronous remote transfer. Furthermore, in the system disclosed in Patent Document 1, the arrangement is such that data is transferred in the order of update, and a method that makes it possible to perform data recovery by changing transfer control in accordance with the update information is neither disclosed nor suggested. Moreover, Patent Document 1 neither discloses nor suggests a method for transferring data while maintaining the updating sequence of the updated data in replication of a virtualized file system.

[Patent Document 1]

Japanese Patent Kokai Publication No. JP-P2000-305856A

[Non-Patent Document 1]

EMC Corporation, EMC SRDF, SRDF/A [ONLINE] [retrieved on Jul. 28, 2004], Internet <URL http://japa.emc.com/local/ja/jp/products/networking/srdf.jsp>

[Non-Patent Document 2]

NEC Corporation, SYSTEM GLOBE REMOTE DATA REPLICATION [ONLINE] [retrieved on Jul. 28, 2004], Internet <URL http://www.sw.nec.co.jp/products/istorage/product/software/rdr/index.s html>

### SUMMARY OF THE DISCLOSURE

In the conventional information processing systems, there is no assurance that replication will be performed in replica storage in a sequence that will make data recovery possible. At the standby site, therefore, operation cannot be resumed.

Further, in the system disclosed in Patent Document 1, transfer to the remote center is carried out while maintaining the updating sequence and therefore recovery of data is possible. However, there are structural limitations and data transfer control is fixed to the sequence of data updating. Control while varying the transfer sequence in accordance with, e.g., storage position of transfer data in storage or type of data cannot be performed. In addition, Patent Document 1 neither discloses nor suggests a method for transferring data while maintaining the updating sequence of the updated data in replication of a virtualized file system.

Accordingly, an object of the present invention is to provide a system, method and computer program that make it possible to achieve data recovery in storage at a replication destination while improving transfer efficiency.

Another object of the present invention is to provide a system, method and computer program that make it possible to achieve data recovery in storage at a replication destination in the replication of a virtualized file system.

The above and other objects are attained by an arbitration apparatus in accordance with an aspect of the present invention, which is placed between a storage system of a replication source and a storage system of a replication destination, wherein transfer between the storage system of the replication source and the storage system of the replication destination is performed via the arbitration apparatus. The apparatus comprises:

acceptance means that receives the update information which has been transferred from the storage system of the replication source;

storing means in which the update information received is temporarily stored;

transmitting means that transmit the update information received to the storage system of the replication destination; and

schedule means that controls scheduling of transmission of the update information received, based upon address information of the update information in storage of said replication source, so as to transmit the update information received immediately or preferentially to the storage system of a replication destination, or to store the update information received in the storing means temporarily and transmit the update information hat has been temporarily stored in the storing means to the storage system of the replication destination on the occurrence of a prescribed event.

According to the present invention, the arbitration apparatus includes acceptance means for receiving update information that has been transmitted from the storage system of the replication source; a transmission scheduler for controlling scheduling of transmission of the update information, which has been accepted by the acceptance means, by referring to a transmission rule that decides a sequence of application of the update information in the storage system of the replication destination; and transmitting means for receiving a transmit command from the transmission scheduler and transmitting the update information to the storage system of the replication destination.

In the present invention, the transmission scheduler retrieves any transmission rule that is applicable based upon identification information and address information of the update information in storage of the transmission source, and, in accordance with type of operation stipulated by the transmission rule retrieved, exercises control to store the update information in storing means temporarily and then transmit the update information on the occurrence of a prescribed event, or to transmit the update information immediately.

In the present invention, the storage system of the replication source and the storage system of the replication destination each have a plurality of storages.

In the present invention, a transmission rule has, as one set, storage information of the storage system of the replication source, volume information, offset information indicating the range of a block in a volume, and type of transmitting operation of the update information.

In the present invention, the acceptance means associates and delivers update information, a storage ID in the storage system of the replication source and an acceptance ID that corresponds to the order in which the update information was accepted to the transmission scheduler as one set of information.

In the present invention, types of transmitting operations of update information include at least one or a combination of a plurality of: immediate transmission; control of whether or not to transmit based upon available storage in the storing means; control of whether or not to transmit update information based upon elapsed time following reception; control of whether or not to transmit in response to an externally applied command; control of transmission in accordance with a specified time; and control of transmission based upon priority.

In the present invention, the storage system of the replication source is virtualized, and the apparatus further comprises address translation means for making a translation to a logical address upon acquiring mapping information indicating state of virtualization of the storage system of the replication source, wherein storage identification information and block number of the storage system of the replication source are calculated from an address virtualized in accordance with the mapping information, and sequence of updating of the data in storage of the replication source of the update information is rationalized based upon the transmission rule.

In the present invention, the apparatus further comprises address translation means for acquiring an address from the storage information of the storage system of the replication source and address information of the update information and converting the address to a logical address based upon the mapping information.

In the present invention, the acceptance means extracts address information from the update information, acquires a logical address from the address translation means, converts the address information from the update information to a logical address and delivers the logical address together with an acceptance ID to the transmission scheduler.

In the present invention, the storage system of the replication destination may be so adapted as to store a logical image of the storage system of the replication source.

In the present invention, mapping information is acquired from file-mapping management means that manages mapping of files of the storage system of the replication source.

In the present invention, the mapping information includes, in accordance with a file and meta-information, identification information of the file, an address within the file and address information within storage of the storage system of the replication source.

In the present invention, in a case where a transmission rule corresponding to the update information that has been transferred from the storage system of the replication source is not indicative of immediate transmission, the transmission scheduler stores the update information in the storing means and sends the acceptance means a command to send back a response to the storage system of the replication source; in a case where the transmission rule is indicative of transmission upon elapse of a fixed period of time, the transmission scheduler is set in such a manner that a transmission-trigger event will occur at this time; and in a case where the transmission rule is indicative of immediate transmission, the transmission scheduler sends the transmitting means a transmit command and, upon receiving a response, sends the acceptance means a command to send back a response to the storage system of the replication source.

In the present invention, when a transmission-trigger event occurs, the transmission scheduler extracts the update information, which has been stored in the storing means, in accordance with the acceptance sequence and, if the corresponding transmission rule matches the trigger of transmission, instructs the transmitting means to transmit the update information.

In the present invention, if transmission rules corresponding to update information are plural in number, then transmission according to the transmission rule having the highest priority is executed.

A system according to the present invention comprises the system of the replication source, the above-described arbitration apparatus, the storage system of the replication destination, and recovery means for recovering the storage system of the replication destination.

According to the present invention, there is provided a replication control method in which transfer between a storage system of a replication source and a storage system of a replication destination is performed via an arbitration apparatus placed between the storage system of the replication source and the storage system of the replication destination, the method comprising

a step of said arbitration apparatus receiving update information that has been transferred from the storage system of said replication source;

a step of said arbitration apparatus exercising control of the transfer of the update information received, based upon address information of the update information in storage of said replication source, so as to transfer the update information received to the storage system of said replication destination immediately or preferentially, or to store said update information received in storing means temporarily and transmit the update information that has been stored in the storing means to the storage system of a replication destination on the occurrence of a prescribed event.

A computer program according to the present invention causes a computer to execute the following processing, the computer constituting an arbitration apparatus placed between a storage system of a replication source and a storage system of a replication destination, transfer between the storage system of the replication source and the storage system of the replication destination being performed via the arbitration apparatus:

processing for receiving update information that has been transferred from the storage system of said replication source; and

processing for exercising control of the transfer of the update information received, based upon address information of the update information in storage of said replication source, so as to transfer the update information received to the storage system of said replication destination immediately or preferentially, or to store said update information received in storing means temporarily and transmit the update information hat has been stored in the storing means to the storage system of a replication destination on the occurrence of a prescribed event.

The computer program according to the present invention may be adapted to retrieve transmission rules, which decide a sequence of application of the update information in the storage system of the replication destination, based upon at least one item of information from among identification information of the update information in storage of the transmission source, volume information and block address information in the volume, and transfer the update information to the storage system of the replication destination in accordance with the transmission rule retrieved.

A computer program according to the present invention causes a computer to execute the following processing, the computer constituting an arbitration apparatus placed between a storage system of a replication source and a storage system of a replication destination, transfer between the storage system of the replication source and the storage system of the replication destination being performed via the arbitration apparatus: acceptance processing for receiving update information that has been transmitted from the storage system of the replication source; transmission scheduler processing for controlling scheduling of transmission of the accepted update information by referring to a transmission rule that decides a sequence of application of the update information in the storage system of the replication destination; and transmission processing for receiving a transmit command from the transmission scheduler and transmitting the update information to the storage system of the replication destination.

In the computer program according to the present invention, the transmission scheduler retrieves any transmission rule that is applicable based upon identification information and address information of the update information in storage of the transmission source, and, in accordance with type of operation stipulated by the transmission rule retrieved, exercises control to store the update information in storing means temporarily and then transmit the update information on the occurrence of a prescribed event, or to transmit the update information immediately.

In the computer program according to the present invention, the storage system of the replication source and the storage system of the replication destination each have a plurality of storages.

In the computer program according to the present invention, the transmission rule has the following as an entry: storage information of the storage system of the replication source, volume information, offset information indicating the range of a block in a volume, and type of transmitting operation of the update information.

In the computer program according to present invention, the acceptance processing associates and delivers update information, storage ID in the storage system of the replication source and acceptance ID that corresponds to the order in which the update information was accepted to the transmission scheduler as one set of information.

In the computer program according to present invention, types of transmitting operations of update information include at least one or a combination of a plurality of: immediate transmission; control of whether or not to transmit based upon available storage in the storing means; control of whether or not to transmit update information based upon elapsed time following reception; control of whether or not to transmit in response to an externally applied command; control of transmission in accordance with a specified time; control of transmission based upon priority; and synchronous transfer and asynchronous transfer in case of immediate transmission.

In the computer program according to present invention, the storage system of the replication source is virtualized, and the program further includes: address translation processing for making a translation to a logical address upon acquiring mapping information indicating state of virtualization of the storage system of the replication source; and processing for calculating storage identification information and block number of the storage system of the replication source from an address virtualized in accordance with the mapping information, and rationalizing sequence of updating of the data in storage of the replication source of the update information based upon the transmission rule.

In the computer program according to the present invention, the program further includes address translation processing for acquiring an address from storage information of the storage system of the replication source and from address information of the update information and converting the address to a logical address based upon the mapping information.

In the computer program according to the present invention, it may be so arranged that the acceptance processing extracts address information from the update information, acquires a logical address from the address translation processing, converts the address information from the update information to a logical address and delivers the logical address together with an acceptance ID to the transmission scheduler.

In the computer program according to the present invention, the storage system of the replication destination may be so adapted as to store a logical image of the storage system of the replication source.

In the computer program according to the present invention, it may be so arranged that mapping information is acquired from file-mapping management means that manages mapping of files of the storage system of the replication source. The mapping information includes, in accordance with a file and meta-information, identification information of the file, an address within the file and address information within the storage unit of the storage system of the replication source.

In the computer program according to the present invention, in a case where a transmission rule corresponding to the update information that has been transferred from the storage system of the replication source is not indicative of immediate transmission, the transmission scheduler stores the update information in the storing means and sends the acceptance means a command to send back a response to the storage system of the replication source; in a case where the transmission rule is indicative of transmission upon elapse of a fixed period of time, the transmission scheduler makes a setting in such a manner that a transmission-trigger event will occur at this time; and in a case where the transmission rule is indicative of immediate transmission, the transmission scheduler sends the transmission processing a transmit command and, upon receiving a response, sends the acceptance means a command to send back a response to the storage system of the replication source.

In the computer program according to the present invention, when a transmission-trigger event occurs, the transmission scheduler extracts the update information, which has been stored in the storing means, in accordance with the acceptance sequence and, if the corresponding transmission rule matches the trigger of transmission, instructs the transmission processing to transmit the update information.

In the computer program according to the present invention, the transmission scheduler stores transmission rule corresponding to the update information in association with the update information, and it is permissible to eliminate processing for retrieving transmission rules corresponding to the update information when a transmission-trigger event occurs.

In the computer program according to the present invention, if transmission rules corresponding to update information are plural in number, then the transmission scheduler may exercise control so as to execute transmission according to the transmission rule having the highest priority.

The meritorious effects of the present invention are summarized as follows.

In accordance with the present invention, an arbitration apparatus disposed between the storage system of a replication source and the storage system of a replication destination controls, in variable fashion, the manner of transfer in accordance with update information transferred from the storage system of the replication source to the storage system of the replication destination. As a result, recovery of data in the storage system of the replication destination is assured while the efficiency of transfer is improved. In accordance with the present invention, the manner of transfer, such as synchronous transfer, asynchronous transfer and transfer on the occurrence of an event, is controlled in variable fashion based upon address information, etc., of update information. As a result, the manner of replication can be changed over in conformity with the data that has been stored in the storage of the replication source.

In accordance with the present invention, even if the storage system of the replication source has been virtualized, it is possible to update the storage system of the replication destination and to recover data in the storage system of the replication destination.

Still other features and advantages of the present invention will become readily apparent to those skilled in this art from the following detailed description in conjunction with the accompanying drawings wherein only the preferred embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating the configuration of a first embodiment of the present invention;

FIG. 2 is a diagram illustrating the configuration of an arbitration apparatus according to the first embodiment;

FIG. 3 is a diagram illustrating a temporary storage format according to the first embodiment;

FIG. 4 is a diagram illustrating an example of transmission rules according to the first embodiment;

FIG. 5 is a flowchart illustrating an example of the operation of a transmission scheduler according to the first embodiment;

FIG. 6 is a diagram illustrating an example of storage of a temporary storage format according to the first embodiment;

FIG. 7 is a flowchart illustrating another example of operation of a transmission scheduler according to the first embodiment;

FIG. 8 is a flowchart illustrating a further example of operation of a transmission scheduler according to the first embodiment;

FIG. 9 is a diagram illustrating a temporary storage format according to the first embodiment;

FIG. 10 is a diagram illustrating the configuration of a second embodiment of the present invention;

FIG. 11 is a diagram illustrating an example of the structure of an arbitration apparatus according to the second embodiment;

FIG. 12 is a flowchart illustrating an example of the operation of a transmission scheduler according to the second embodiment;

FIG. 13 is a flowchart illustrating another example of operation of a transmission scheduler according to the second embodiment;

FIG. 14 is a flowchart illustrating a further example of operation of a transmission scheduler according to the second embodiment;

FIG. 15 is a diagram illustrating the configuration of a third embodiment of the present invention;

FIG. 16 is a diagram illustrating an example of the structure of an arbitration apparatus according to the third embodiment;

FIG. 17 is a diagram illustrating an example of a temporary storage format according to the third embodiment;

FIG. 18 is a diagram illustrating an example of transmission rules according to the third embodiment;

FIG. 19 is a flowchart illustrating an example of operation of acceptance means according to the third embodiment;

FIG. 20 is a flowchart illustrating an example of the operation of a transmission scheduler according to the third embodiment;

FIG. 21 is a flowchart illustrating another example of operation of a transmission scheduler according to the third embodiment;

FIG. 22 is a flowchart illustrating a further example of operation of a transmission scheduler according to the third embodiment;

FIG. 23 is a diagram illustrating the configuration of a fourth embodiment of the present invention;

FIGS. 24A to 24C are diagrams illustrating examples of mapping information possessed by file-mapping management means according to the fourth embodiment;

FIG. 25 is a diagram illustrating the configuration of an arbitration apparatus according to the fourth embodiment;

FIG. 26 is a diagram illustrating an example of transmission rules according to the fourth embodiment;

FIG. 27 is a flowchart illustrating an example of the operation of a transmission scheduler according to the fourth embodiment;

FIG. 28 is a flowchart illustrating another example of the operation of a transmission scheduler according to the fourth embodiment; and

FIG. 29 is a flowchart illustrating a further example of the operation of a transmission scheduler according to the fourth embodiment.

### PREFERRED EMBODIMENTS OF THE INVENTION

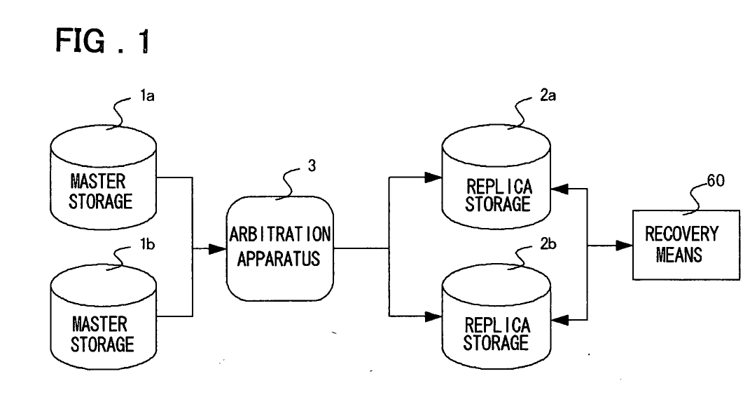

Preferred embodiments of the present invention will now be described in detail with reference to the accompanying drawings. The present invention is implemented through an arbitration apparatus (3 in FIG. 1) when replication is performed between master storage (1a and 1b in FIG. 1) and replica storage (2a and 2b in FIG. 1).

On the basis of transmission rules stored and held within the arbitration apparatus 3, the latter transmits update information, which has been sent from master storage, to replica storage. In replica storage, the update information is applied in a sequence that is based upon the transmission rules.

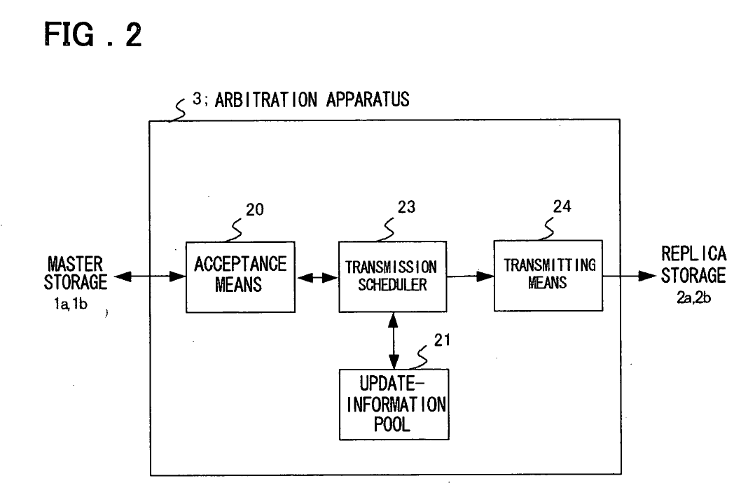

Rules for deciding an application sequence, which is for applying the update information appropriately in replica storage, are stipulated in the transmission rules beforehand. The arbitration apparatus 3 has a transmission scheduler (23 in FIG. 2) which, in accordance with the transmission rule, performs scheduling in such a manner that individual items of transmission information will be applied to replica storage in the appropriate sequence.

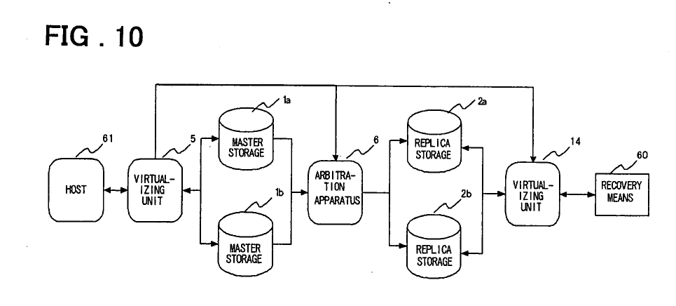

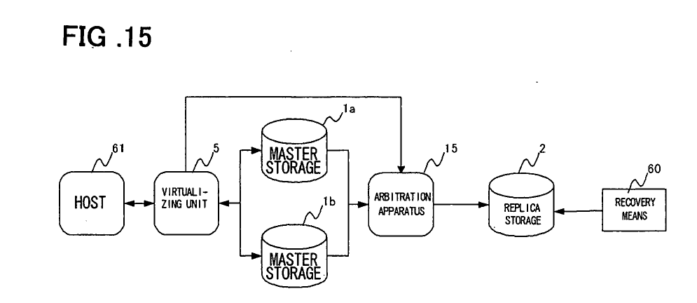

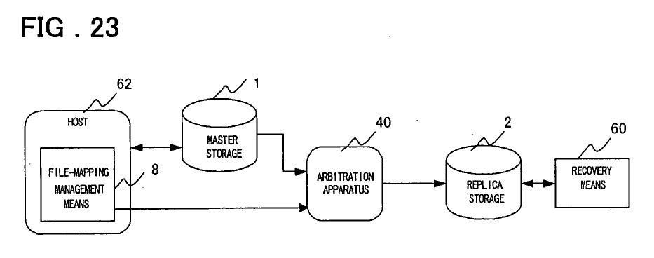

The present invention is such that in a case where master storage has been virtualized (see FIGS. 10 and 15) or in a case where mapping has been performed by file-mapping management means (8 in FIG. 23), replication is performed between master storage and replica storage via an arbitration apparatus (6 in FIG. 10, 15 in FIG. 15 and 40 in FIG. 23) that applies an address translation to a virtual address.

On the basis of transmission rules stored and held within the arbitration apparatus and mapping information acquired from a virtualizing apparatus or mapping information from file mapping means, the arbitration apparatus transmits update information, which has been sent from master storage; to replica storage. The update information is applied in replica storage in accordance with a sequence that is based upon the transmission rule.

The transmission rules are previously recorded rules for deciding an application sequence, which is for appropriately applying update information in replica storage in a state in which master storage has been virtualized. In the arbitration apparatus, use is made of mapping information for converting update information from master storage, which has not been virtualized, to a virtualized state. On the basis of the converted update information and the rules, the arbitration apparatus performs scheduling in such a manner that individual items of transmission information are applied to replica storage in the appropriate sequence. Embodiments of the invention will now be set forth

### First Embodiment

A first embodiment of the present invention will be described in detail with reference to the drawings. As shown in FIG. 1, the first embodiment of the invention includes a plurality of master storages 1a and 1b, replica storages 2a and 2b, and an arbitration apparatus 3 that intercedes in communication for replication between the master storages 1a and 1b and replica storages 2a and 2b. According to this embodiment, recovery means 60 is connected to the replica storages 2a and 2b. Although the master storage group and replica storage group are each illustrated as comprising two storages for the sake of simplicity, the present invention as a matter of course is limited to such an arrangement.

The master storages 1a and 1b are utilized as one set from a host, not shown. For example, in the case of a database system, a table is contained in master storage 1a and a journal is contained in master storage 1b. Alternatively, it may be so arranged that all volumes of master storage 1a and some volumes of master storage 1b contain tables and the remaining volumes of master storage 1b contain journals.

Although not a specific limitation, it is assumed below that a replica of master storage 1a corresponds to replica storage 2a and that a replica of master storage 1b corresponds to replica storage 2b.

In a case where a host (not shown) has issued a write request to master storage 1a, the latter stores the write request in a storage medium (hard-disk drive, etc.) or cache (neither of which are shown) within the master storage unit la, transmits update information, which is formed from the write request, to replica storage 2a, waits for a response from replica storage 2a and then notifies the host of completion of the write operation.

It should be noted that operation with regard to a read request from the host to master storage 1a is similar to an ordinary storage read operation.

In this embodiment, the update information is composed of the following information:

information (referred to as “address information” below) indicating a data block in storage that has been updated by a write operation; and

data after updating (referred to as “updated data” below).

In this embodiment, the arbitration apparatus 3 is placed between master storage and replica storage, as illustrated in FIG. 1. As long as the update information passes between the master storages 1a and 1b and replica storages 2a and 2b without fail when these communicate, the arbitration apparatus 3 may be placed at any position.

Further, it may be so arranged that the arbitration apparatus 3 is concealed from master storages 1a and 1b and replica storages 2a and 2b. For example, an arrangement may be adopted in which the arbitration apparatus 3 is seen as an address of replica storage 2 when the arbitration apparatus 3 is viewed from master storage 1, and such that the arbitration apparatus 3 is seen as an address of replica storage 1 when the arbitration apparatus 3 is viewed from master storage 2.

Alternatively, the arbitration apparatus 3 may be placed in the manner of network gateways between the master storages 1a and 1b and replica storages 2a and 2b. If this arrangement is adopted, it will appear as if the master storages 1a and 1b are communicating with the replica storages 2a and 2b. In actuality, however, they communicate with the arbitration apparatus 3. It will appear as if the replica storages 2a and 2b are communicating with the master storages 1a and 1b. In actuality, however, they communicate with the arbitration apparatus 3.

In another example, the arbitration apparatus 3 may of course be explicitly inserted between the master storages 1a and 1b and replica storages 2a and 2b. In this case, it may be so arranged that the master storages 1a and 1b transmit explicitly to the arbitration apparatus 3 and such that the arbitration apparatus 3 discriminates the master storage that is the source of transmission of received update information and sends the update information to the corresponding replica storage based upon a corresponding relationship (replication-pair information), which has been set previously in the arbitration apparatus 3, between master storage and replica storage.

The replica storages 2a and 2b are storages that have a replica function for replication. When they are severed from the master storages 1a and 1b, the replica storages 2a and 2b process a read request or write request from a host, not shown.

This embodiment is such that upon receiving update information, the replica storages 2a and 2b write updated data to a block that corresponds to the address information contained in the update information and send back a response via the arbitration apparatus 3 to the master storages 1a and 1b that were the source of transmission of the update information.

FIG. 2 is a diagram illustrating an example of the structure of the arbitration apparatus 3 in FIG. 1. As shown in FIG. 2, the arbitration apparatus 3 includes acceptance means 20 for receiving pdate information from the master storages 1a and 1b; an update-information pool 21 for storing update information temporarily; a transmission scheduler 23 for scheduling transmission of the update information; and transmitting means 24 for transmitting the update information to the replica storages 2a and 2b. Of course, it may be so arranged that the processing and functions of these means is implemented by a program executed by a computer constituting the arbitration apparatus 3. The same holds true in the other embodiments that follow.

Upon receiving update information from the master storages 1a and 1b, the acceptance means 20 forms a temporary storage format by compiling the following:

update information;

information (referred to as a “master ID” below) indicating the master storage that is the source of transmission;

a number (referred to as “acceptance ID” below) indicating the order in which the update information was accepted; and

information on the destination of the update information.

When the update information is received by the acceptance means 20, the update information is stored in a receive buffer (not shown) within the acceptance means 20. The update information contained in the temporary storage format may be a pointer of the receive buffer and size information.

The acceptance means 20 delivers the temporary storage format created to the transmission scheduler 23.

Next, the acceptance means 20 waits for a command from the transmission scheduler 23 to send back a response and transmits the response to the master storages 1a and 1b, which are the transmission destination of update information.

Although it does not constitute a particular limitation, the transmission scheduler 23 has an internal storage device (not shown) that stores, for every stationary storage format of update information accepted from the acceptance means 20, transmission rules for deciding processing (transmit immediately, store or, in case of storage, the trigger of transmission) suited to the format. It may be so arranged that the transmission rules are stored in a storage device (not shown) to which the transmission scheduler 23 can reference within the arbitration apparatus 3.

An example of transmission rules used in this embodiment will be described.

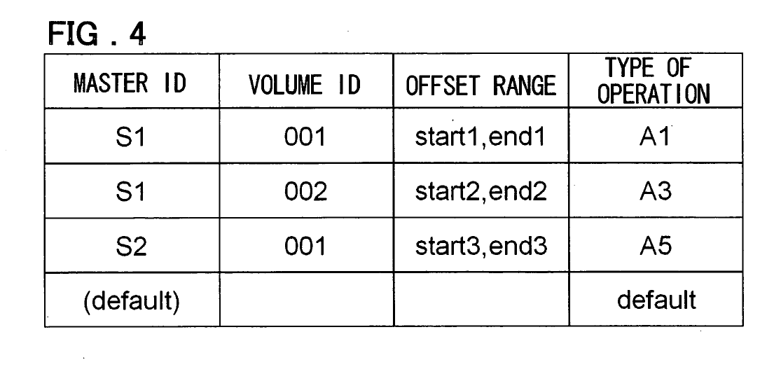

A transmission rules is formed as a table having a plurality of entries, and each entry possesses the following information, by way of example, as illustrated in FIG. 4:

master ID;

volume ID (information specifying a volume within master storage);

offset range [leading end (start) and tail end (end)] (information for specifying the range of a block within a volume); and

information indicating type of operation.

It may be so arranged that if the master ID contained in the temporary storage format of the update information agrees with the master ID of a transmission rule, then a value indicating that the other items, namely volume ID and offset value, etc., need not be considered is recorded in the volume ID and offset range.

It may be so arranged that if the master ID and volume ID contained in the temporary storage format of the update information agree, then a value indicating that offset value need not be considered is recorded in the volume ID and offset range.

Alternatively, it may be so arranged that a value (default value) indicating operation in a case where the temporary storage format of the update information from the acceptance means 20 does not match with any entry of the transmission rule is recorded in the master ID, volume ID and offset range. In this case, if the address information of the update information does not match with an entry of the transmission rule, then a default operation is executed with regard to transmission of this update information.

Further, in a case where transmission rules are evaluated in the order of entry priority and an evaluated temporary storage format is applicable to a plurality of entries, then transmission of the entry having the highest degree of priority is executed. It may be so arranged that priority information is stored in an entry, or it may be so arranged that entries are arrayed in the order of priority and are searched and evaluated from the beginning.

The operations or combinations thereof set forth below may be used as types of operations for transmitting update information in the transmission scheduler 23. Although there is no particular limitation, as result of retrieval of a transmission rule, the following are the types of transmission operations stipulated by entries that have been collated with update information:

(A1) transmit immediately;

(A2) do not transmit until available capacity of update-information pool 21 falls below a threshold value;

(A3) do not transmit update information for a predetermined period of time following reception;

(A4) transmit update information upon elapse of a predetermined period of time following reception;

(A5) do not transmit until issuance of an external command;

(A6) do not transmit until a predetermined time arrives; and

(A7) in relation to update information to be transmitted, transmit if update information having a higher priority than this update information has not accumulated in the update-information pool 21.

It may be so arranged that with the exception of immediate transmission, any of the plurality of operations [namely (A2) to (A7)] may be combined. Further, in the case of immediate transmission, either synchronous or asynchronous may be stipulated, as will be described later. Furthermore, in regard to (A7), the priority of update information corresponds to the priority of an entry that matches the update information in the transmission scheduler 23 as a result of retrieval of the transmission rule.

It may be so arranged that (A1) to (A7) are stored upon being encoded into the entries of the transmission rules. In the case of (A3), etc., it may be so arranged that the set time can be specified in variable fashion as a parameter. Further, in the case of (A5), it may be so arranged that the external command is made fixed or is made variable, in which case the content of the command can be set in variable fashion.

In the case of (A6), it may be so arranged that the time can be set in variable fashion in the field indicating the type of operation of the transmission rule.

By combining (A4) and (A2) through an OR operation, the following (A8) is set, by way of example:

(A8) transmit update information upon elapse of 10 minutes following reception or when update-information pool 21 runs out of available capacity.

Further, by combining (A2) and (A5) through an OR operation, the following (A9) is set:

(A9) transmit when update-information pool 21 runs out of available capacity or when an external command is issued.

Further, by combining (A2) and (A6) through an OR operation, the following (A10) is set:

(A10) transmit when update-information pool 21 runs out of available capacity or when designated time arrives.

Further, by combining (A6) and (A4) through an OR operation, the following (A11) is set:

(A11) when an external command has been issued, transmit upon elapse of a time greater than a designated time period.

Described next will be a specific examples of events that serve as opportunities to transmit update information in the transmission scheduler 23 according to this embodiment. By way of example (B1) to (B3), etc., below are used as transmission-trigger events:

(B1) in transmission upon elapse of a predetermined period of time following reception of update information, the predetermined period of time elapses;

(B2) a predetermined time arrives; and

(B3) the available capacity of the update-information pool 21 falls below a threshold value.

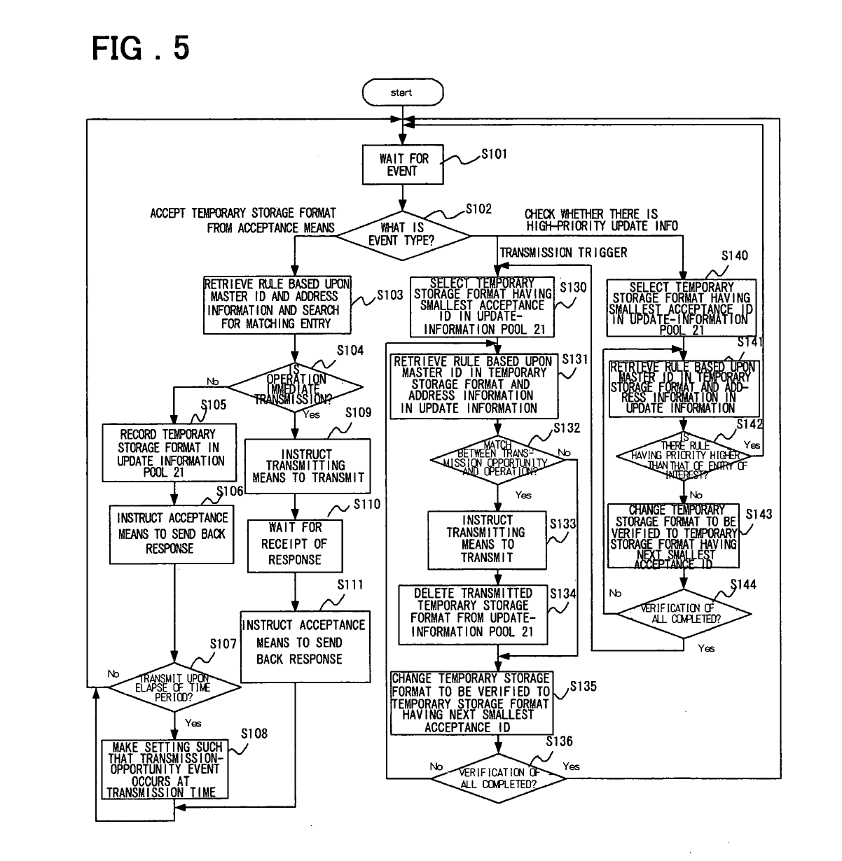

FIG. 5 is a flowchart illustrating the operation of the transmission scheduler 23 according to this embodiment. The operation of the transmission scheduler 23 will be described with reference to FIG. 5.

When an event occurs in an event wait state (step S101), the transmission scheduler 23 discriminates the type of event (step S102). If a temporary storage format of the update information has been accepted from the acceptance means 20, the transmission scheduler 23 retrieves a transmission rule based upon the master ID and address information of the temporary storage format and searches for the entry of the transmission rule with which the master ID matches (step S103).

If the type of operation of the matching transmission rule is not immediate transmission (“NO” branch at step S104), the transmission scheduler 23 stores the temporary storage format in the update-information pool 21 (step S105).

The transmission scheduler 23 instructs the acceptance means 20 to send back a response to master storage (step S106).

Upon receiving update information, the transmission scheduler 23 determines whether to transmit the update information upon elapse of a predetermined period of time (step S107). If the update information is not to be transmitted upon elapse of the predetermined period of time (“NO” branch at step S107), then control returns to step

If the update information is to be transmitted upon elapse of the predetermined period of time (“YES” branch at step S107), then the transmission scheduler 23 sets a timer (not shown) (step S108) in such a manner that the transmission-trigger event will occur at transmission time. Control then returns to step S101.

In case of immediate transmission (“YES” branch at step S104), the transmission scheduler 23 instructs the transmitting means 24 to transmit the update information (step S109).

The transmission scheduler 23 waits for a response from replica storage at the destination to which the update information was transmitted (step S110) and instructs the acceptance means 20 to send back a response (step S111).

When the result of discriminating the type of event at step S102 is that the event is a transmission-trigger event [any one of items (B1) to (B3) mentioned above], the transmission scheduler 23 selects the temporary storage format having the smallest acceptance ID from among the temporary storage formats that have been stored in the update-information pool 21 (step S130).

The transmission scheduler 23 retrieves an entry of a transmission rule based upon the master ID of the temporary storage format and the address information contained in the update information (step S131).

If the trigger of transmission that has occurred and the type of operation of the retrieved transmission rule match (“YES” branch at step S132), then the transmission scheduler 23 instructs the transmitting means 24 to transmit the update information of the temporary storage format having the acceptance ID (step S133). After the update information is transmitted, the transmission scheduler 23 deletes the temporary storage format of the transmission from the update-information pool 21 (step S134).

The temporary storage format stored in the update-information pool 21 and that is to undergo verification is changed to that having the next smallest acceptance ID (step S135).

When the processing of steps S131 to S135 is completed with regard to all acceptance IDs of temporary storage formats that have been stored in the update-information pool 21 (“YES” branch at step S136), control returns to step S101.

If it is determined that update information having a high priority has not been stored in the update-information pool 21, then the transmission scheduler 23 selects the temporary. storage format having the smallest acceptance ID from among the temporary storage formats that have been stored in the update-information pool 21 (step S140).

The transmission scheduler 23 retrieves an entry of a transmission rule based upon the master ID of the temporary storage format and the address information contained in the update information (step S141).

If there is a rule having a priority higher than that of the entry of interest (“YES” branch at step S142), then control returns to step

If there is a rule having a priority lower than that of the entry of interest (“NO” branch at step S142), then what is to be verified is changed to one having the next smallest acceptance ID (step S143).

If the processing of steps S141 to S144 has been confirmed with regard to all temporary storage formats that have been stored in the update-information pool 21 (“YES” branch at step S144), then control proceeds to step S130 and processing for occurrence of a transmission trigger.

In this embodiment, a response is returned to master storage (1a and 1b) at the stage where update information corresponding to an entry that is not for immediate transmission according to the transmission rule is registered in the update-information pool 21, and therefore replication of the update information is asynchronous replication.

With regard to update information corresponding to an entry that is for immediate transmission, after a response from replica storage is sent back, a response is sent back from the arbitration apparatus 3 to master storage (1a and 1b) and a response is sent back to the host. Accordingly this replication of the update information is synchronous replication.

The transmission scheduler 23 according to this embodiment exercises control in such a manner that all update information corresponding to the same entry of transmission rules is transmitted in regard to a temporary storage format. However, it may be so arranged that a transition is made to event wait at the stage where some of the update information has been transmitted.

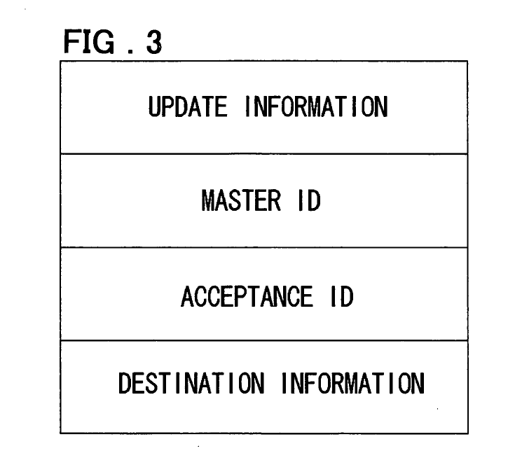

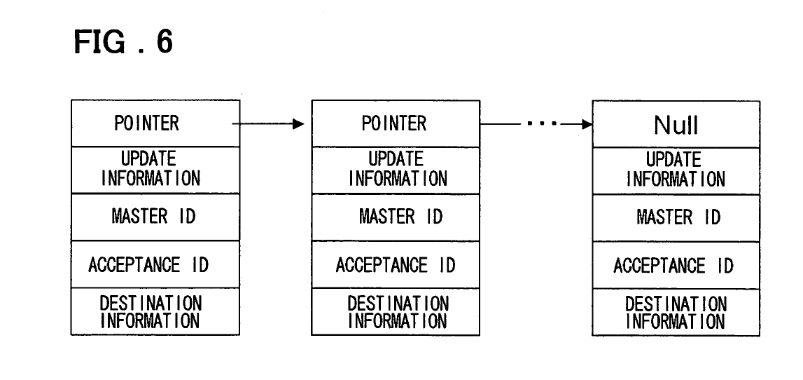

Next, an example of management for storing a temporary storage format in the update-information pool 21 will be described. In this embodiment, a temporary storage format of update information is provided with a pointer area that stores information indicating the beginning of another temporary storage format, and management is performed based upon a linear list format. The update information is made variable in length. That is, as illustrated in FIG. 6, the arrangement of FIG. 3 is additionally provided with a pointer area that stores information indicating the beginning of the next temporary storage format. A plurality of temporary storage formats are linked, and information (e.g., Null) indicative of the tail end is stored in the pointer area of the temporary storage format at the tail end. It should be noted that the field in which the pointer area is placed in the temporary storage format is not limited to the leading field; the pointer area may be placed in any field of the format.

Alternatively, a file may be created for every temporary storage format and managed as a file. In this case, the update-information pool 21 would contain information (address and size) for accessing the file. Or, update information may be stored in a file and the field of the update information of the temporary storage format may be adopted as address information of the file, as mentioned above.

In a case where collation is performed between a master ID, etc., of a temporary storage format and an entry of a transmission rule, the transmission scheduler 23 basically performs the collation in order of decreasing age of the acceptance IDs.

When the transmitting means 24 is delivered the temporary storage format from the transmission scheduler 23 and is instructed to transmit, the transmitting means 24 extracts the destination of the update information and the update information and transmits the update information to the destination. If a response is sent back to the arbitration apparatus 3 from replica storage at the destination to which the update information was transmitted, the transmission scheduler 23 is notified of arrival of the response and processing is terminated.

A database will be described as a specific example of transmission rules according to this embodiment.

If journal data (also referred to as a log, journal log or redo log) in a database system is transferred in accordance with the updating sequence and the data in master storage and that is replica storage agree in the initial state, then a table of the database can be recovered based upon the journal data. It is so arranged that if master storage la contains a table and master storage 1b contains journal data, then master storage 1b transfers update information of the journal data to replica storage 2b immediately, and master storage 1a transfers the update information of the data at any arbitrary timing. By adopting this arrangement, even if master storage becomes unusable owing to the occurrence of a failure, replica storage can be set substantially to the latest state.

More specifically, the transmission scheduler 23 of the arbitration apparatus 3 makes it possible to achieve transfer in a recoverable state in a database system by using the following rule:

transfer storage containing the journal data as well as the volume in the storage immediately; and

transmit other storage and volumes arbitrarily.

If this arrangement is adopted, it will suffice to provide, at least between the arbitration apparatus 3 and replica storage, a network having a band that is capable of transferring journal data transmitted immediately.

A file system will be described as a specific example of transmission rules according to this embodiment.

In a journaling file system that performs metadata logging, if the system is such that journal information, meta-information such as file management information and file data are stored in respective ones of different storage units or volumes at least at addresses, then the metadata can be reconstructed in replica storage from the journal information by performing the following:

transferring the journal information immediately at a first priority;

transferring the meta-information such as file management information one time for 30 seconds at a second priority; and

transferring the file data at a third priority when there is no higher priority.

This means that it is possible to recover the file management information as the latest information by a recovery program using a command [fsck in the Linux (registered trademark) system and scandisk in the Windows (registered trademark) system] for performing file check and recovery.

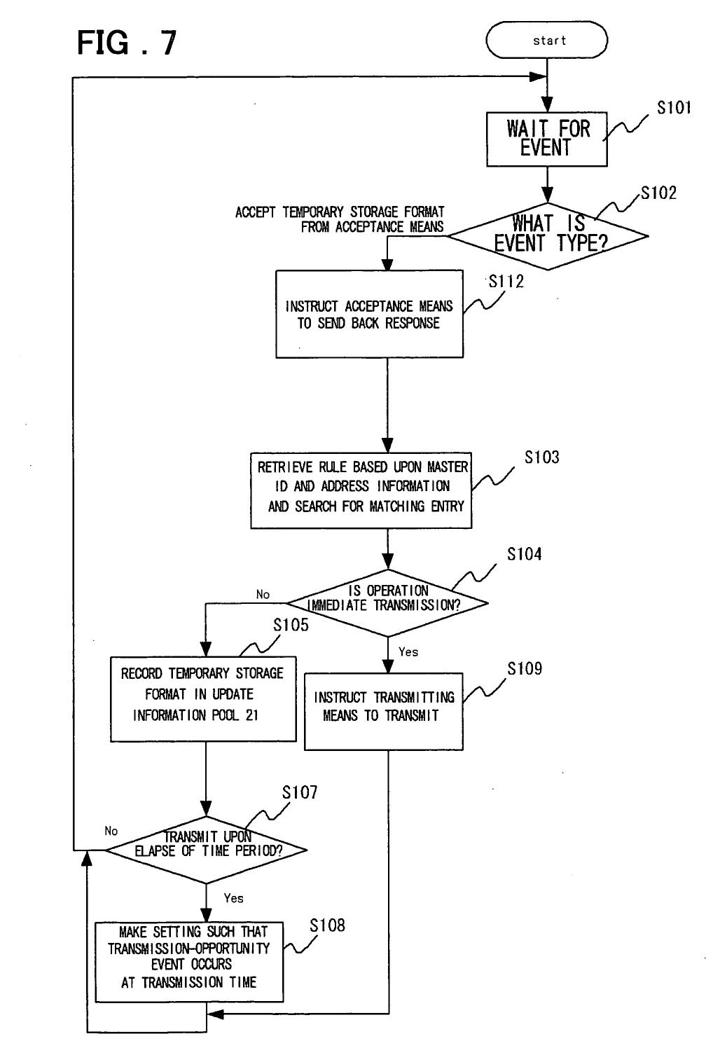

Another example of operation of the transmission scheduler 23 of FIG. 2 will be described. FIG. 7 is a diagram illustrating a modification of operation of the transmission scheduler 23 in this embodiment. Processing in FIG. 7 other than that of the event where a temporary storage format is accepted from the acceptance means 20 of FIG. 2 is the same as that shown in FIG. 5 and is not shown.

When a temporary storage format is accepted from the acceptance means 20 in the example illustrated in FIG. 7, the transmission scheduler 23 instructs the acceptance means 20 to send back a response (step S112).

The transmission scheduler 23 retrieves a transmission rule based upon the master ID and address information of the temporary storage format and searches for the entry that matches (step S103).

If the transmission rule is not immediate transmission (“NO” branch at step S104), the transmission scheduler 23 stores the temporary storage format in the update-information pool 21 (step S105).

Upon receiving update information, the transmission scheduler 23 determines whether to transmit the update information upon elapse of a predetermined period of time (step S107). If the update information is not to be transmitted upon elapse of the predetermined period of time, then control returns to step S101.

If the update information is to be transmitted upon elapse of the predetermined period of time, then transmission scheduler 23 sets a timer (step S108) in such a manner that the transmission-trigger event will occur at transmission time. Control then returns to step S101.

In case of immediate transmission at step S104, the transmission scheduler 23 instructs the transmitting means 24 to transmit the update information (step S109).

The example shown in FIG. 7 is an asynchronous operation. Even in case of immediate transmission, therefore, the processing for transfer to the replica storage units 2a and 2b has no effect upon the master storage units 1a and 1b. The example shown in FIG. 7 is such that in relation to a transmission rule of an entry that matches a master ID of a temporary storage format, all update information of temporary storage formats which correspond to the same entry is transmitted to replica storage at the destination. However, all of the update information of temporary storage formats correspond to the same entry need not be transmitted; it may be so arranged that a transition is made to event wait of step S101 at the stage where some of the update information of a plurality of matching temporary storage formats could be transmitted.

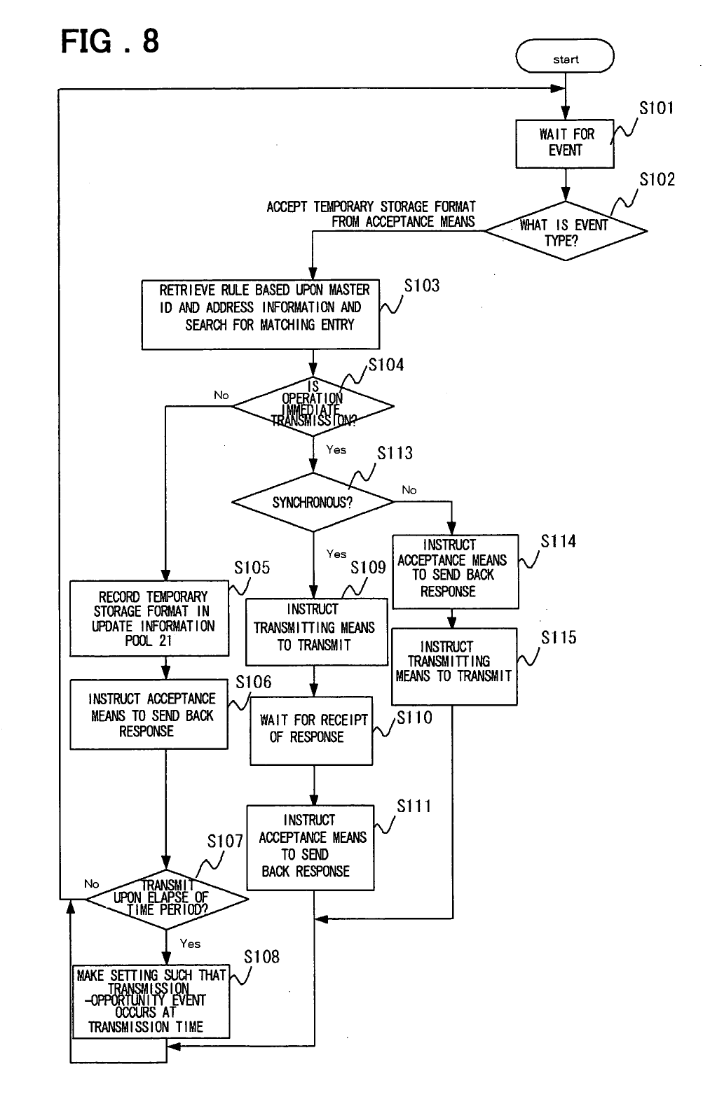

Another example of operation of the transmission scheduler 23 of FIG. 2 will be described. FIG. 8 is a diagram illustrating a further operation of the transmission scheduler 23. Processing other than that of the event where a temporary storage format is accepted from the acceptance means 20 is the same as that shown in FIG. 5 and is not shown.

According to this operation, immediate transmission is divided into two types, namely synchronous and asynchronous, by the transmission rules.

If the result of the determination made at step S104 is that the operation is immediate transmission, then it is determined whether transmission is synchronous or asynchronous (step S113). In case of synchronous transmission (“YES” branch at step S113), an operation identical with that of steps S109 to S111 of FIG. 5 is performed. In case of asynchronous transmission (“NO” branch at step S113), on the other hand, the transmission scheduler 23 instructs the acceptance means 20 to send back a response (step S114) and instructs the transmitting means 24 to transmit (step S115).

In the case of the example shown in FIG. 8, it is possible to switch between synchronous replication (transfer of a response from replica storage) and asynchronous replication (response by the acceptance means) depending upon storage or the data block in storage. That is, depending upon storage or the data block in storage, it is possible to switch between an instance where the influence of replication is not imposed upon processing of master storage (asynchronous replication) and an instance where complete duplication of data is guaranteed (synchronous replication). In other words, how replication is carried out can be changed over appropriately in conformity with the data contained in storage.

In the example of FIG. 8 as well, in relation to a transmission rule that collates with a master ID of a temporary storage format, all update information of temporary storage formats corresponding to the same entry is transmitted to replica storage at the destination. However, all of the update information of matching temporary storage formats need not be transmitted; it may be so arranged that a transition is made to event wait of step S101 at the stage where some of the update information of a plurality of matching temporary storage formats could be transmitted. Further, it may be so arranged that in a case where there is a match with a plurality of entries among transmission rules that match the master ID, etc., of a temporary storage format, the entry having the highest priority is selected and transmission is performed in accordance with the operation of this entry.

A further modification of operation of the transmission scheduler described with reference to FIGS. 5, 7 and 8 will now be described.

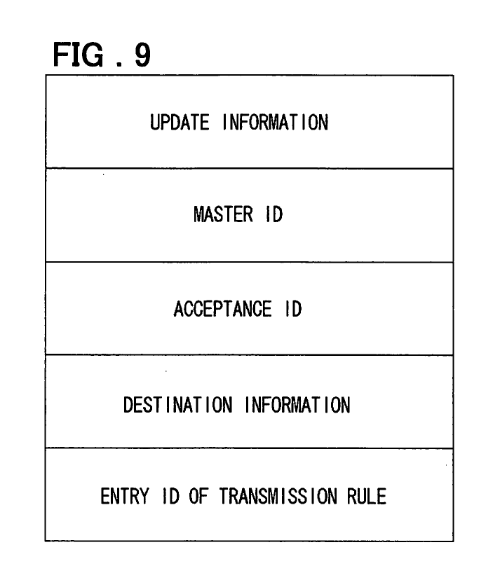

In the three examples set forth above, it may be so arranged that a temporary storage format of update information is provided beforehand with an area for recording the ID (entry number) of an entry of a transmission rule, as illustrated in FIG. 9.

When the transmission scheduler 23 accepts a temporary storage format from the acceptance means 20 and retrieves a transmission rule, the ID corresponding to the entry of the applied transmission rule is recorded beforehand in the field of the entry ID of the transmission rule of the temporary storage format in cases other than immediate transmission.

When the transmission scheduler 23 performs collation between a temporary storage format and a transmission rule in response to occurrence of a transmission-trigger event, using the entry ID that has been stored in the temporary storage format makes it possible to eliminate retrieval of the actual transmission rule. That is, when a transmission-trigger event occurs, retrieval of a transmission rule in the transmission scheduler 23 becomes unnecessary and, as a result, processing time can be curtailed. In other words, the processing capability of the arbitration apparatus is improved.

Next, the recovery means 60 (see FIG. 1) of this embodiment will be described. If the master storages 1a and 1b can no longer operate due to failure or scheme of operation, processing is resumed using the replica storages 2a and 2b.

Recovery of data in the replica storages 2a and 2b is performed by the recovery means 60 before processing is resumed. Recovery processing by the recovery means 60 comprises reading data out of the replica storages 2a and 2b and changing locations of data mismatch in the replica storage units to a state in which there is no mismatch.

The recovery means 60 is mounted in the host (not shown) that uses replica storage.

A database will be described as a specific example of recovery by the recovery means 60.

In the database system, journal data is applied to table data in order of decreasing age, thereby enabling restoration to the original state (this corresponds to processing referred to as “crash recovery”).

In replica storage, it is difficult to continue holding all journal data from the initial state onward.

If at the point in time where old journal data is discarded the table data in replica storage is in a state newer than the state that was updated by the discarded old journal data, then it is possible to achieve the newest state from the remaining journal data.

If the period of time until journal data is discarded is, say, one week, the table data need only be transferred to replica storage before expiration of this period (i.e., before one week passes following the transfer of the journal data). The method below is available to achieve this.

Specifically, a transmission rule is set in the arbitration apparatus 3 in such a manner that if a period of time shorter than one week has elapsed following arrival of update information from master storage, then the update information is transmitted.

In replica storage, transmission is caused to occur by an externally applied command a fixed time before journal data is discarded.

A journaling file system will be described as another specific example of recovery processing. With regard to the history of updating of meta-information in the journal data, the recovery means 60 changes the meta-information in order of decreasing age of updating in the journal. The meta-information thus attains a non-contradictory state.

### Second Embodiment

A second embodiment of the present invention will now be described in detail with reference to the drawing. In the second embodiment of the present invention, master storage and replica storage are virtualized in the same manner and replication is performed in the form of a physical image. FIG. 10 is a diagram illustrating the system configuration of this embodiment. The master storages 1a and 1b and the replica storages 2a and 2b, respectively, are in one-to-one correspondence. The master storages 1a and 1b have been virtualized by a virtualizing unit 5. A host 61 uses the virtualized master storage units 1a and 1b in the form of a logical image. It should be noted that the replica storages 2a and 2b also are used upon being virtualized by a virtualizing unit 14. Further, the virtualizing units 5 and 14 are for virtualizing the master storages 1a and 1b and replica storages 2a and 2b, respectively. The targeted storages merely differ and virtualization is performed by the same mapping information.

The mapping information of the virtualizing units 5 and 14 is the same in the initial state. When the mapping information is changed by the virtualizing unit 5, the virtualizing unit 5 notifies the virtualizing unit 14 of the change so that the mapping information is maintained in the synchronous state.

The master storages 1a and 1b are initialized by the virtualizing unit 5. The following method can be used as the method of virtualization:

(C1) Master storage 1a and master storage 1b are connected (if data has reached the end of master storage 1a, a transition is made to the beginning of master storage 1b).

(C2) Master storage 1a and master storage 1b are subjected to striping (master storage 1a and master storage 1b are used alternately on a per-block basis).

(C3) In the manner of HSM (Hierarchical Storage Management), data blocks used most often are adopted as the master storage 1a and those used not so often are adopted as the master storage 1b in conformity with frequency of use. It should be noted that when a block is moved in HSM, this is attended by the writing of data the target of which is replication.

The operation of the virtualizing units 5 and 14 according to this embodiment will be described next. Upon receiving a read/write request from the host 61, the virtualizing unit 5 converts the read/write request to a read/write request to a corresponding block of the corresponding master storages 1a and 1b based upon mapping information, issues the request to the master storages 1a and 1b and, if the request is a write request, transfers the write data.

Responses from the master storages 1a and 1b are transferred to the host 61. In the case of a read request, the data read out also is transferred to the host 61 along with the transfer of the responses. Although the host 61 is indicated as being a single host in FIG. 10 for the sake of simplicity, it goes without saying that the hosts may be plural in number.

Mapping according to this embodiment will be described next. Mapping information is constructed in the form of a table obtained as a collection of entries, in which the following constitute a single entry: an address (logical address) in the virtualized state, an ID (master ID) of master storage containing an area corresponding to the logical address, and an address (physical address) of the area in master storage. It does not matter if the logical address and physical address are a pair comprising a volume number and an address.

In a case where striping is performed, the mapping information can be expressed by a mathematical formula.

The virtualized storage and master storage are divided into blocks based upon the striping width, and we let X represent a block number of virtualized storage, S an ID of master storage and B a block number within master storage. If storage is divided into N storages, then S and B are given by the following equations:
S=f(X/N) (1)
B=m(X,N) (2)

It should be noted that f(x) is a function for discarding digits to the right of the decimal point, and m(x,y) is a function for returning the remainder obtained by dividing x by y.

In a case where virtualized storages have been connected, the mapping information can be expressed by a mathematical formula. Let X represent a block number of virtualized storage, S an ID of master storage and B a block number within master storage. If the size of storage is M, then S and B are given by the following equations:
S=f(X/M) (1)′
B=m(X,M) (2)′

It should be noted that f(x) is a function for truncating digits to the right of the decimal point, and m(x,y) is a function for returning the residue obtained by dividing x by y.

In this embodiment, an arrangement in which an arbitration apparatus 6 is placed between the master storages 1a and 1b and the replica storages 2a and 2b is similar to the arrangement of the first embodiment described above. That is, the arbitration apparatus 6 may be concealed or may be disposed explicitly.

The operation of master storage in this embodiment is the same as that of the first embodiment. Further, the update information in this embodiment is the same as that of the first embodiment. In this embodiment, operation when the replica storages 2a and 2b accept the update information is the same as that described in the first embodiment.

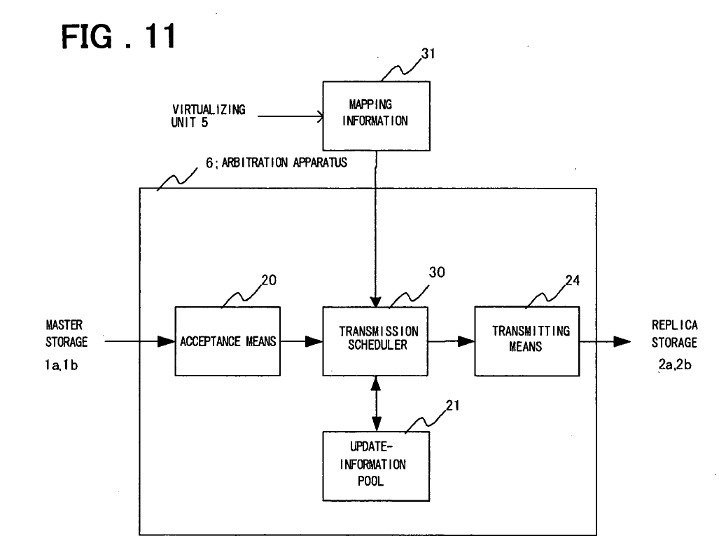

FIG. 11 is a diagram illustrating the configuration of the arbitration apparatus 6 according to this embodiment. As shown in FIG. 11, mapping information 31 is supplied from the virtualizing unit 5 to a transmission scheduler 30 of the arbitration apparatus 6. As the operation of the acceptance means 20 in arbitration apparatus 6 is the same as that of the acceptance means 20 in arbitration apparatus 3 of the first embodiment, this operation need not be described again. As mentioned above, the mapping information 31 has a set of the three items consisting of logical address, master ID and physical address, or the ID of master storage and block number within master storage given by Equations (1) and (2), respectively.

In the transmission rules, the types of operations are the same as those of the first embodiment with the exception of the fact that the transmission rules are in a state (logical addresses) virtualized by the virtualizing unit 5. The entries are the following, as illustrated in FIG. 4:

volume ID (information specifying a volume in virtualized storage);

offset range (leading end and tail end) (information for specifying the range of a block in a virtualized volume); and

information indicating type of operation.

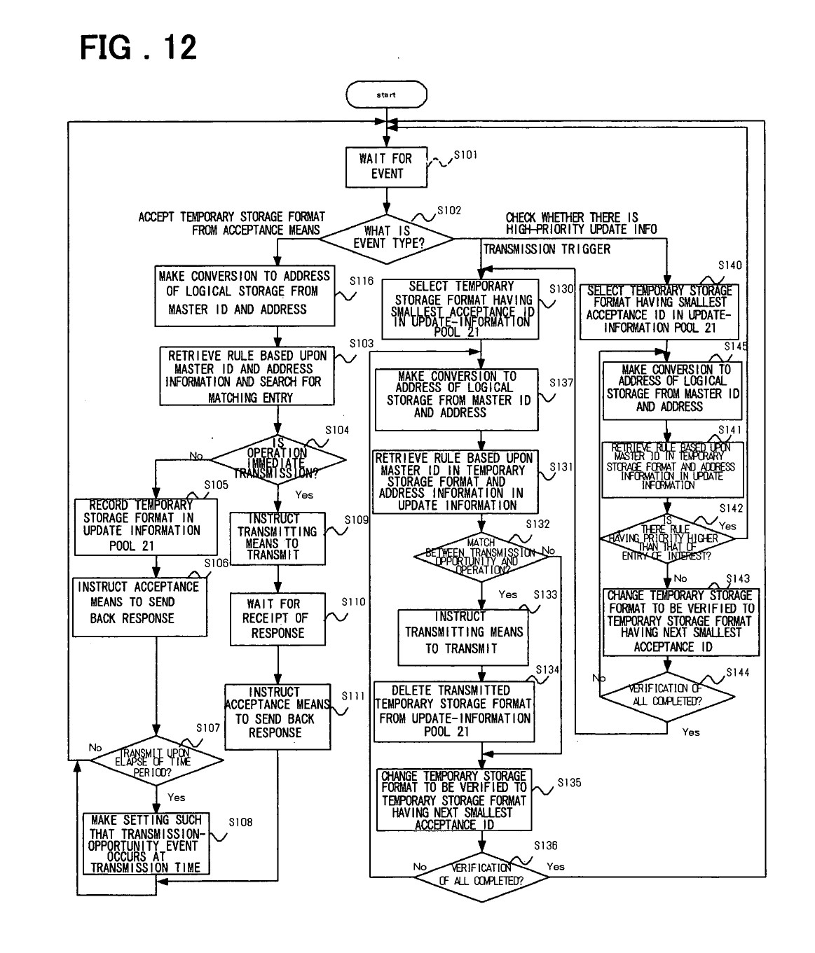

The operation of the transmission scheduler 30 of this embodiment will now be described. FIG. 12 is a flowchart illustrating operation of the transmission scheduler 30 of this embodiment. Processing identical with that shown in FIG. 5 is designated by like step numbers.

The operation of the transmission scheduler 30 is the same as that of the transmission scheduler 23 of the first embodiment with the exception of the fact that steps (S116, S137, S145) of acquiring an address from a master ID and address information, which is contained in address information of the update information, and making a translation to a logical address based upon the mapping information 31 acquired from the virtualizing unit 5 are inserted before the retrieval of a transmission rule.

Although a translation from a virtualized logical address to a physical address has been described above, here a reverse translation (from a physical address to a block number of virtualized storage) based upon mapping information will be described.

In a case where the mapping information has been constructed in the form of a table obtained as a collection of entries each single one of which includes a logical address, a master ID and a physical address,

the master ID of the mapping information is adopted as the master ID; and

the address of the address information of the update information is adopted as the physical address;

the logical address of a matching entry is adopted as the logical address from a plurality of entries (logical address, master ID, physical address) of the mapping information, and this is used in retrieving a transmission rule.

Further, in a case where striping is performed, let X represent the block number of virtualized storage, S the ID of master storage and B the block number within master storage. If storage is divided into N storages, then X is given by the following equation:
X=B×N+S (3)

If storages have been connected, let X represent a block number of virtualized storage, S an ID of master storage and B a block number within master storage. If the size of master storage is M, then X is given by the following equation:
X=M×S+B (4)

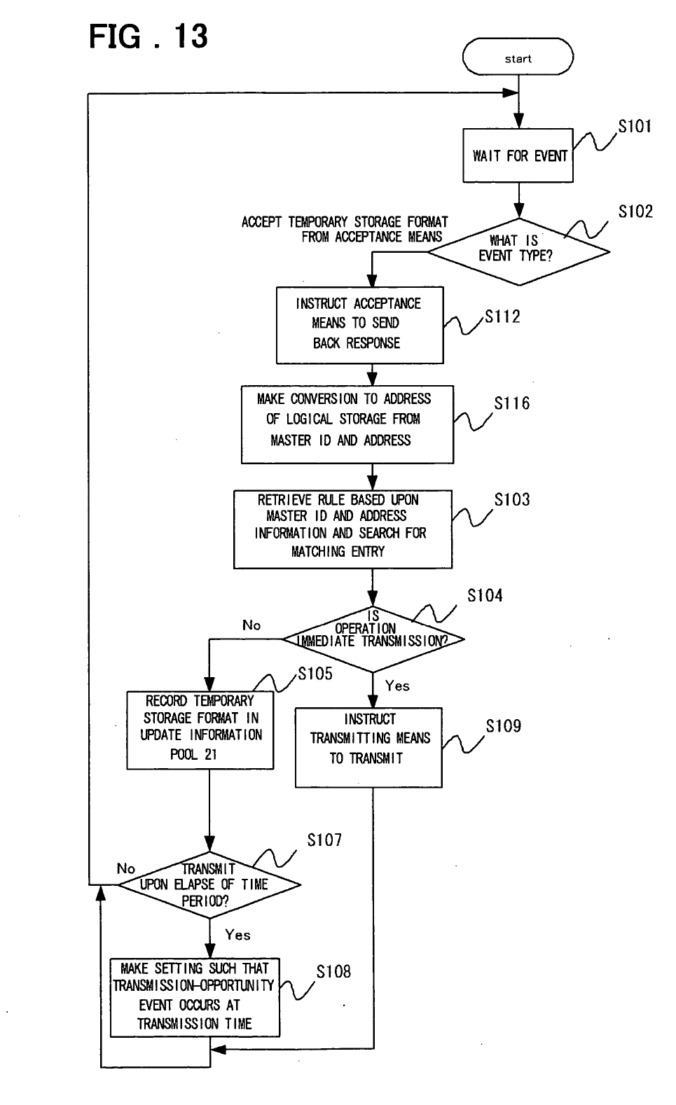

Another example of operation of the transmission scheduler 30 according to this embodiment will now be described. FIG. 13 is a flowchart illustrating another operation of the transmission scheduler 30. The operation of the transmission scheduler 30 is the same as that of the first embodiment shown in FIG. 7 with the exception of the fact that a step (S116) of acquiring an address from a master ID and address information, which is contained in address information of the update information, and making a translation to a logical address based upon the mapping information 31 acquired from the virtualizing unit 5 is inserted before the retrieval of a transmission rule.

In the processing procedure of FIG. 13, operation is the asynchronous replication operation. Accordingly, even in a case where immediate transmission is performed, processing for performing a transfer to replica storage has no effect upon master storage. The example shown in FIG. 13 is such that in relation to a transmission rule of an entry that collates with a master ID, etc., of a temporary storage format, all update information of temporary storage formats corresponding to the same entry is transmitted to replica storage at the destination. However, all of the update information of matching temporary storage formats need not be transmitted; it may be so arranged that a transition is made to event wait of step S101 at the stage where some of the update information of a plurality of matching temporary storage formats could be transmitted.

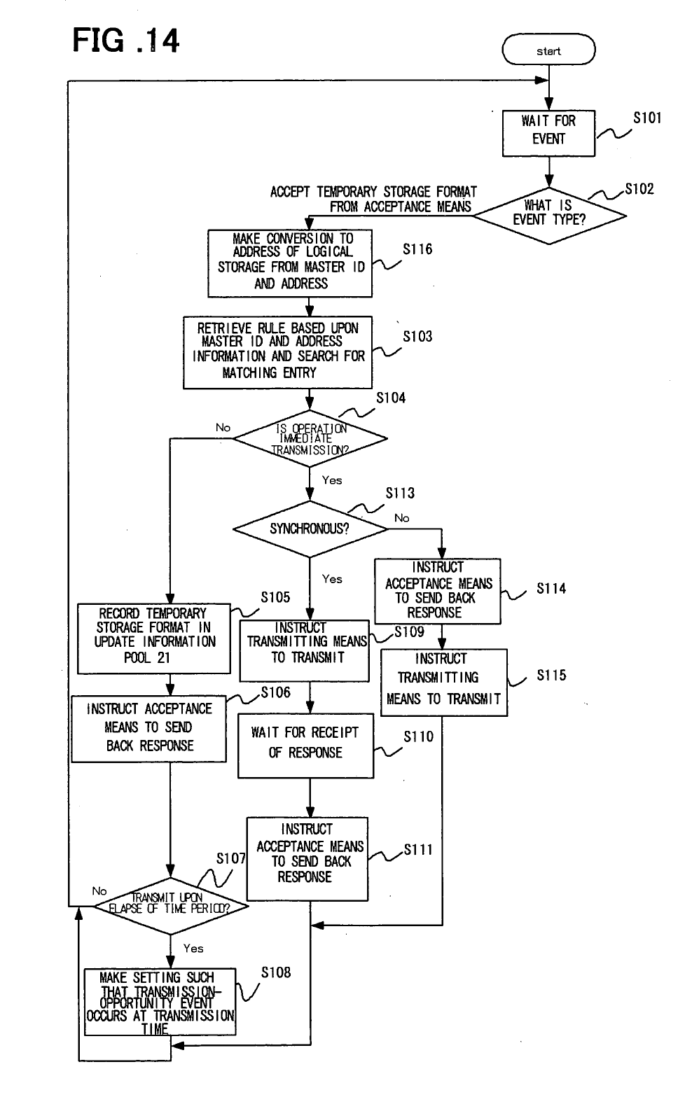

Another example of operation of the transmission scheduler 30 will be described. FIG. 14 is a flowchart illustrating another operation of the transmission scheduler 30. The operation of the transmission scheduler 30 is the same as that of the first embodiment shown in FIG. 8 with the exception of the fact that step S116 of acquiring an address from a master ID and address information, which is contained in the update information, and making a translation to a logical address based upon the mapping information acquired from the virtualizing unit 5 is newly inserted before the retrieval of a transmission rule.

According to this operation, immediate transmission is divided into two types, namely synchronous and asynchronous, in the transmission rules. It is possible to switch between synchronous replication (transfer of a response from replica storage) and asynchronous replication (response by the acceptance means) depending upon the volume in logical storage or the data block in storage.

That is, depending upon storage or the data block in storage, it is possible to switch between an instance where the influence of replication is not imposed upon processing of master storage (asynchronous replication) and an instance where complete duplication of data is guaranteed (synchronous replication). In other words, how replication is carried out can be changed over appropriately in conformity with the data contained in storage.

The example shown in FIG. 14 is such that in relation to a transmission rule of an entry that collates with a master ID, etc., of a temporary storage format, all update information of temporary storage formats corresponding to the same entry is transmitted to replica storage at the destination. However, all of the update information of matching temporary storage formats need not be transmitted; it may be so arranged that a transition is made to event wait of step S101 at the stage where some of the update information of a plurality of matching temporary storage formats could be transmitted.

Further, as described above with reference to FIG. 9, a temporary storage format may be provided with an area for recording the ID of an entry of a transmission rule in the transmission scheduler 30. An improvement may be made in such a manner that when the transmission scheduler 30 accepts a temporary storage format from the acceptance means 20 and retrieves a transmission rule, the ID corresponding to the entry of the applied transmission rule is recorded in this storage area. It may be so arranged that actual retrieval is eliminated by using this ID at the time of transmission rule retrieval, such as when there is a transmission trigger. By adopting this arrangement, retrieval of a transmission rule becomes unnecessary and, as a result, processing time can be curtailed. In other words, the processing capability of the arbitration apparatus 6 is improved.

In this embodiment, management of temporary storage formats in the update-information pool 21 is identical with management in the first embodiment described above with reference to FIG. 6. Further, operation of the transmitting means 24 also is the same as in the first embodiment.

The recovery means 60 in this embodiment is the same as that of the first embodiment except for the fact that it accesses virtualized replica storage via the virtualizing unit 14.

### Third Embodiment

A third embodiment of the present invention will now be described. FIG. 15 is a diagram illustrating the configuration of the third embodiment. This embodiment is a modification of the second embodiment. Here the master storages 1a and 1b are virtualized by the virtualizing unit 5, and replica storage stores a replica of virtualized master storage. An arbitration apparatus 15 performs a translation between a physical address and a logical address and executes replication.

The master storages 1a and 1b are virtualized by the virtualizing unit 5, and the host 61 uses the virtualized master storages 1a and 1b.

The master storages 1a and 1b are replicated to replica storage 2 in a case where updating has been performed by the host 61.

Replica storage 2 is a replica of the virtualized master storage.

The master storages 1a and 1b send the arbitration apparatus 15 update information for replication. On the basis of mapping information acquired from the virtualizing unit 5, the arbitration apparatus 15 performs a translation to a physical address, changes the update information and transfers it to the replica storage 2.

In this embodiment, the virtualizing unit 5 is the same as the virtualizing unit 5 of the second embodiment.

The operation of the master storages 1a and 1b is the same as that of the second embodiment with the exception of the fact that the communication destination of replication is the arbitration apparatus 15.

Operation when the replica storage 2 has received update information is the same as that of the first embodiment except for the fact that the destination of a response is the arbitration apparatus 15. (In the first embodiment, the destination of the response is the arbitration apparatus 3).

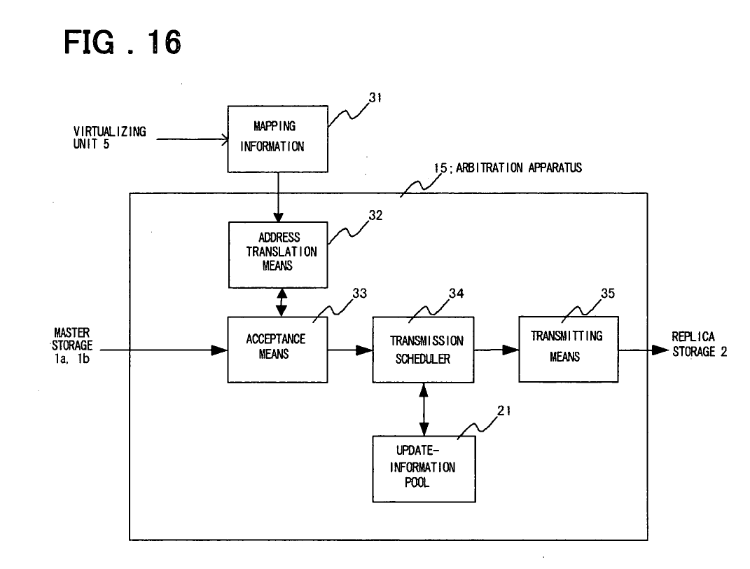

FIG. 16 is a diagram illustrating the configuration of the arbitration apparatus 15 in this embodiment. As shown in FIG. 16, the arbitration apparatus 15 includes acceptance means 33, address translation means 32 for inputting the mapping information 31, a transmission scheduler 34, the update-information pool 21 and transmitting means 35.

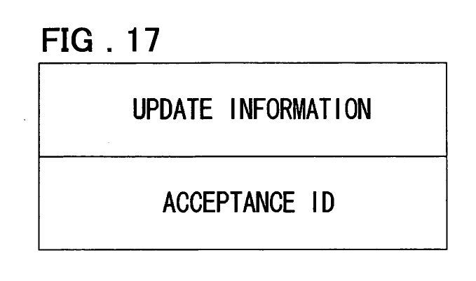

FIG. 17 is a diagram illustrating an example of a temporary storage format. The temporary storage format in this embodiment has update information, which has undergone an address translation, and an acceptance ID. Since replica storage at the destination is a single unit, holding information relating to destination is unnecessary. Since only one type of logical storage is handled, it is also unnecessary to store master ID in the temporary storage format.

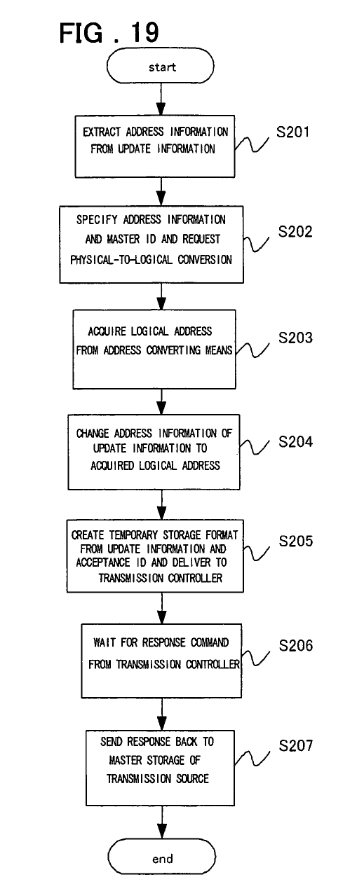

FIG. 19 is a flowchart illustrating operation of the acceptance means 33 according to the third embodiment. Based upon the mapping information 31 that has been acquired from the virtualizing unit 5, the address translation means 32 makes a translation to a logical address using the master ID and address information, which is contained in the update information, delivered from the acceptance means 33.

In a case where a logical address, master ID and physical address constitute one entry and the mapping information 31 comprises a table that is a collection of these entries, the master ID of this mapping information is adopted as the master ID. The address information in the update information is used as a physical address in retrieval of a transmission rule, and the logical address of the matching entry is used as a logical address in retrieval of a transmission rule. Although the temporary storage format does not contain a master ID, the master ID of the mapping information is used by collation with the transmission rule.

Further, if striping is being carried out, we let X represent a block number of virtualized storage, S an ID of master storage and B a block number within master storage. If storage is divided into N storages, then X is given by the following equation:
X=B×N+S (5)

In a case where virtualized storages have been connected, let X represent a block number of virtualized storage, S an ID of master storage and B a block number within master storage. If the size of master storage is M, then X is given by the following equation:
X=M×S+B (6)

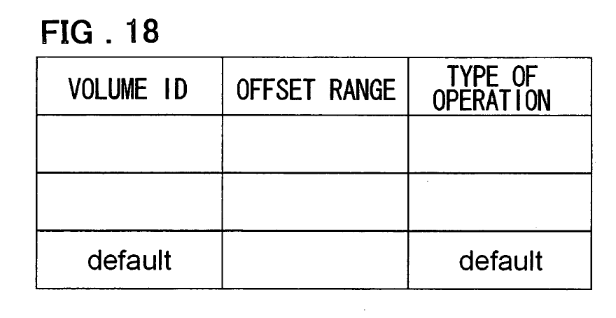

The transmission rules of the transmission scheduler 34 are formed as a table having a plurality of entries, and each entry has the following information, as illustrated in FIG. 18:

volume ID (information specifying a volume in virtualized storage);

offset range (leading end and tail end) (information for specifying the range of a block in a volume); and

information indicating type of operation.

It should be noted that if volume ID matches, a value indicating that the value of an offset need not be taken into consideration may be recorded in the offset range.

It may be so arranged that a value (default value) indicating operation in a case where there has been no match with any entry may be recorded in the offset range.

Further, in a case where the transmission rules are evaluated in the order of entry priority and an evaluated temporary storage format is applicable to a plurality of entries, then the operation of the entry having the highest priority is executed.

In this embodiment, the examples of types of operation and transmission opportunities are similar to those of the transmission rules of the first embodiment.

As illustrated in FIG. 19, the acceptance means 33 extracts address information from the update information (step S201).

The acceptance means 33 specifies the address information and master ID and requests the address translation means 32 to perform a physical-to-logical address translation (step S202).

The acceptance means 33 acquires the logical address from the address translation means 32 (step S203).

The acceptance means 33 changes the address information of the update information by the logical address (step S204).

The acceptance means 33 creates a temporary storage format comprising the update information and acceptance ID and delivers the temporary storage format to the transmission scheduler 34. The acceptance means 33 waits for a response command from the transmission scheduler 34 (step S206).

Upon receiving the response command from the transmission scheduler 34, the acceptance means 33 sends a response back to master storage (step S207).

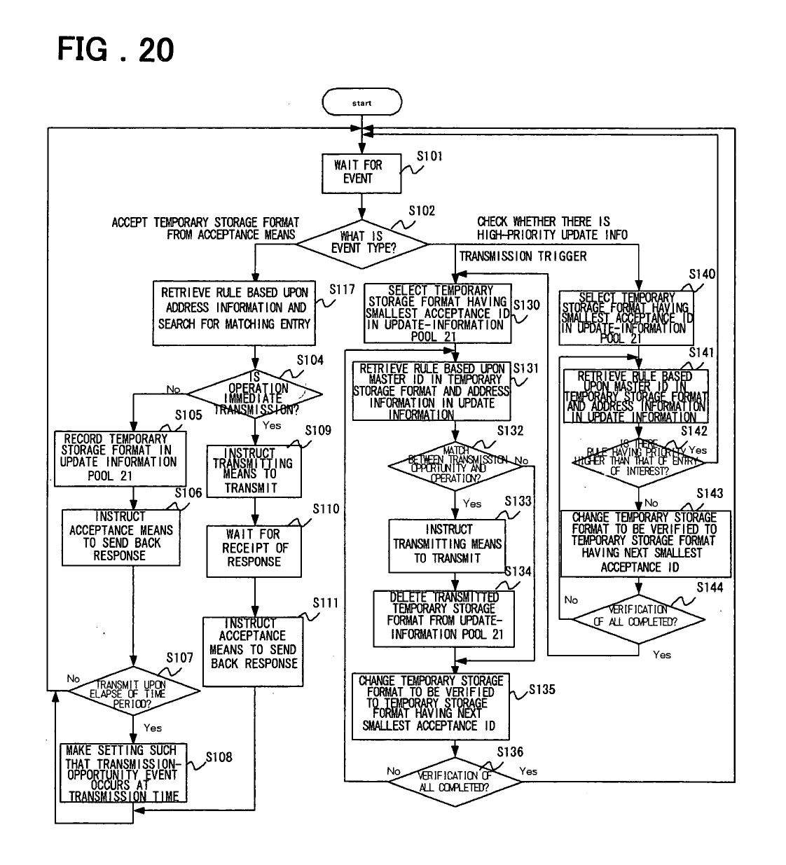

FIG. 20 is a diagram illustrating operation of the transmission scheduler 34 in this embodiment. As shown in FIG. 20, step S103 of FIG. 5 is placed by step S117, at which the transmission scheduler 34 retrieves a transmission rule based upon address information and searches for a matching entry. Other processing in FIG. 20 is identical with that of FIG. 5.

Since a response is sent back to master storage at the stage where update information corresponding to an entry that is not immediate transmission in the transmission rule is recorded in the update-information pool 21, replication is asynchronous replication.

With regard to update information corresponding to an entry that is for immediate transmission, after a response from replica storage is sent back, a response is sent back from the arbitration apparatus 15. Accordingly this replication is synchronous replication. It should be noted that although all update information of temporary storage formats corresponding to the same entry of transmission rules is transmitted to replica storage at the destination, all of the update information of matching temporary storage formats need not be transmitted; it may be so arranged that a transition is made to event wait of step S101 at the stage where some of the update information of a plurality of matching temporary storage formats could be transmitted.

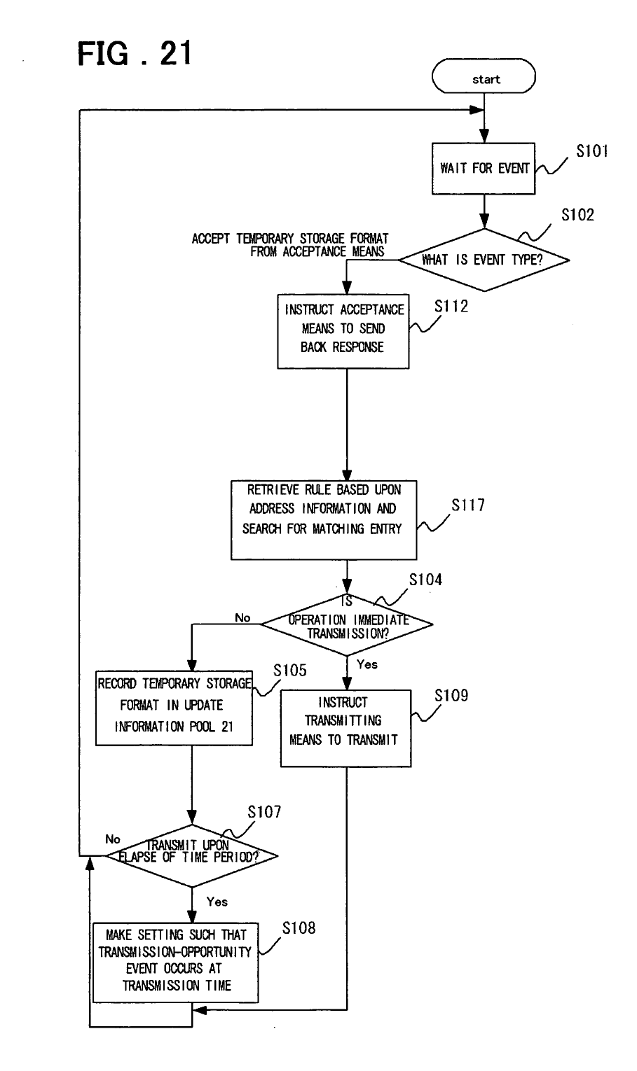

FIG. 21 is a flowchart illustrating another operation of the transmission scheduler 34. With the exception of the event of accepting a temporary storage format from the acceptance means 33 in FIG. 21, processing is the same as that of FIG. 20 and is not illustrated. As shown in FIG. 20, step S103 in FIG. 7 is replaced by step S117, at which the transmission scheduler 34 retrieves a transmission rule based upon address information and searches for a matching entry. Other processing in FIG. 20 is identical with that of FIG. 7.

The operation of FIG. 21 is an asynchronous replication operation. Accordingly, even in case of immediate transmission, processing for performing transfer to replica storage has no effect upon master storage.

It should be noted that although all update information of temporary storage formats corresponding to the same entry of transmission rules is transmitted to replica storage at the destination, all of the update information of matching temporary storage formats need not be transmitted; it may be so arranged that a transition is made to event wait of step S101 at the stage where some of the update information of a plurality of matching temporary storage formats could be transmitted.

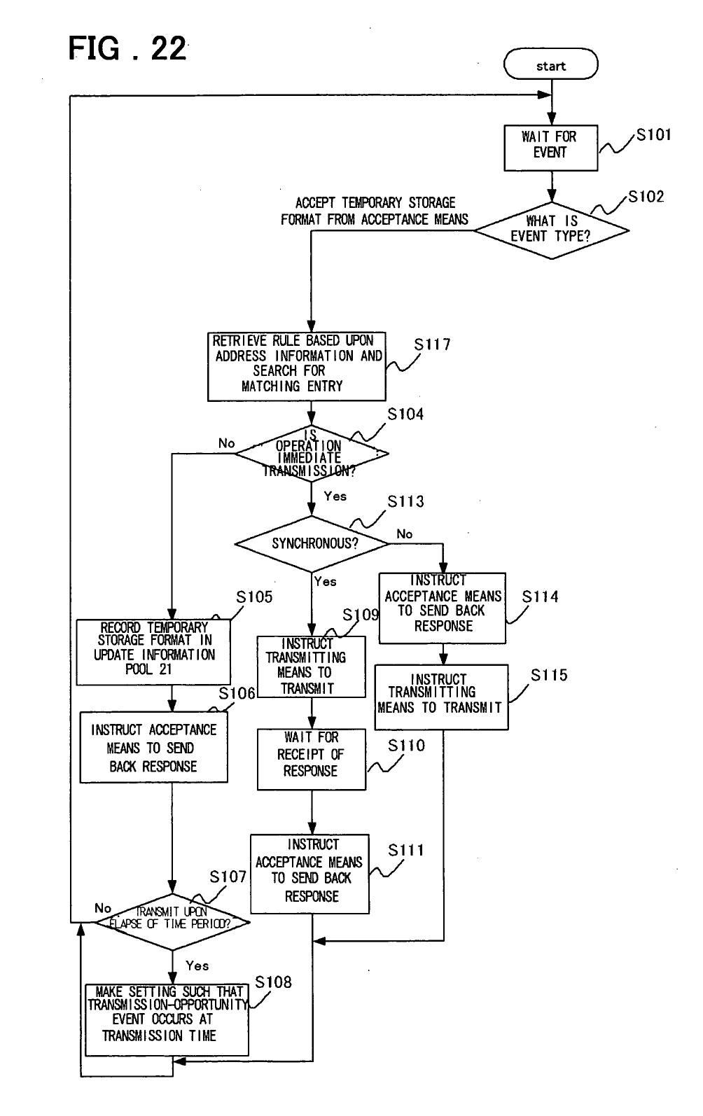

FIG. 22 is a flowchart illustrating another operation of the transmission scheduler 34. With the exception of the event of accepting a temporary storage format from the acceptance means 33 in FIG. 22, processing is the same as that of FIG. 20 and is not illustrated. As shown in FIG. 22, step S103 in FIG. 8 is replaced by the step S117, at which the transmission scheduler 34 retrieves a transmission rule based upon address information and searches for a matching entry. Other processing in FIG. 22 is identical with that of FIG. 8.

In this example, immediate transmission is divided into two types, namely synchronous and asynchronous, by the transmission rules. It is possible to switch between synchronous replication (transfer of a response from replica storage) and asynchronous replication (response by the acceptance means) depending upon storage or the data block in storage. That is, depending upon storage or the data block in storage, it is possible to switch between an instance where the influence of replication is not imposed upon processing of master storage (asynchronous replication) and an instance where complete duplication of data is guaranteed (synchronous replication). In other words, how replication is carried out can be changed over appropriately in conformity with the data contained in storage.

It should be noted that although all update information of temporary storage formats corresponding to the same entry of transmission rules is transmitted to replica storage at the destination, all of the update information of matching temporary storage formats need not be transmitted; it may be so arranged that a transition is made to event wait of step S101 at the stage where some of the update information of a plurality of matching temporary storage formats could be transmitted.

Further, although there is no specific limitation, there is no merit in implementing synchronous replication with regard to what is stored in the update-information pool 21. In this embodiment, therefore, transmission after storage in the update-information pool 21 relates only to asynchronous replication.

In this embodiment also a temporary storage format may be provided with an area for recording the ID of an entry of a transmission rule, as illustrated in FIG. 9. When the transmission scheduler 30 accepts a temporary storage format from the acceptance means 20 and retrieves a transmission rule, the ID (entry number) corresponding to the entry of the applied transmission rule in a case other than immediate transmission is recorded in the area that records the ID of the entry of the temporary storage format. It may be so arranged that actual retrieval is eliminated by using the ID of the entry of the temporary storage format at the time of transmission rule retrieval, such as when there is a transmission trigger. By adopting this arrangement, retrieval of a transmission rule becomes unnecessary and, as a result, processing time can be curtailed. In other words, the processing capability of the arbitration apparatus 15 is improved.

In this embodiment the update-information pool 21 is the same as that of the first embodiment and need not be described again.

In this embodiment, when a temporary storage format is delivered from the transmission scheduler 34 and transmission is instructed, the transmitting means 35 extracts update information from the temporary storage format and transmits the update information to the replica storage 2 set in the arbitration apparatus. If a response is sent back from the destination to which the update information was transmitted, the transmission scheduler 34 is notified of arrival of the response and processing is terminated.

The recovery operation by the recovery means 60 in this embodiment is the same as that of the second embodiment and need not be described again.

### Fourth Embodiment

A fourth embodiment of the present invention will now be described. FIG. 23 is a diagram illustrating the configuration of the fourth embodiment according to the present invention. Shown in FIG. 23 are a host 62, master storage 1, an arbitration apparatus 40, replica storage 2 and recovery means 60. The host 62 has file-mapping management means 8.

When the host accesses a file, address information of the file and a block in the file is converted to address information of a block in master storage 1 using the file-mapping management means 8.

The mapping management method and address translation of a file and a block in storage (block device) are performed using a technique implemented by a file system such as FAT, VFAT, NTFS, UFS, ext2, ext3, riaser FS and xfs, etc.

Further, meta-information such as a directory, FAT, inode or indirect reference block of a file system, and journal information of a journaling file system such as ext3 raise FS or xfs are stored in the master storage 1.

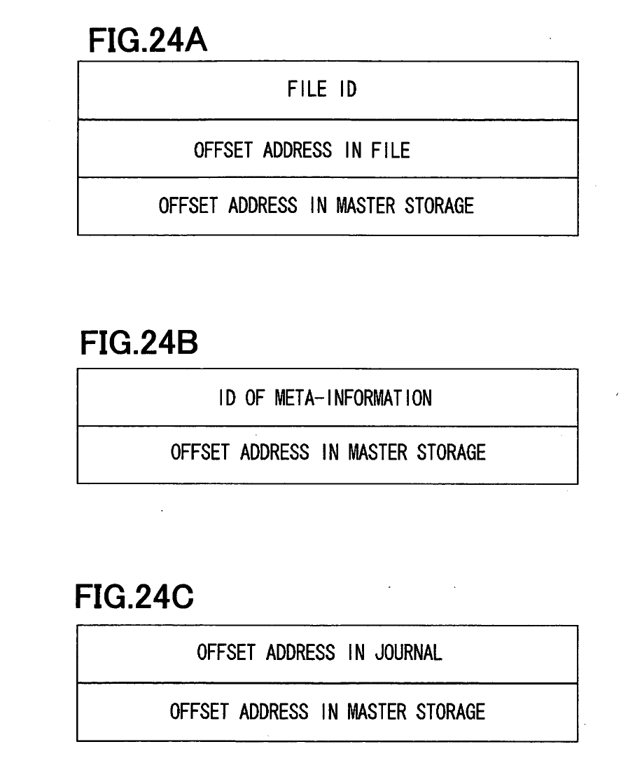

The mapping information possessed by the file-mapping management means 8 comprises the following information, as indicated in FIGS. 24A to 24C:

in case of file data:

file ID (file name);

offset address in the file; and

offset address in master storage;

in case of meta-information:

offset address in the meta-information (ID of meta-information); and

offset address in master storage; and

in case of journal information:

offset address in the journal information; and

offset address in master storage.

The operation of master storage 1 and replica storage 2 is the same as operation of master storage and replica storage, respectively, of the first embodiment.

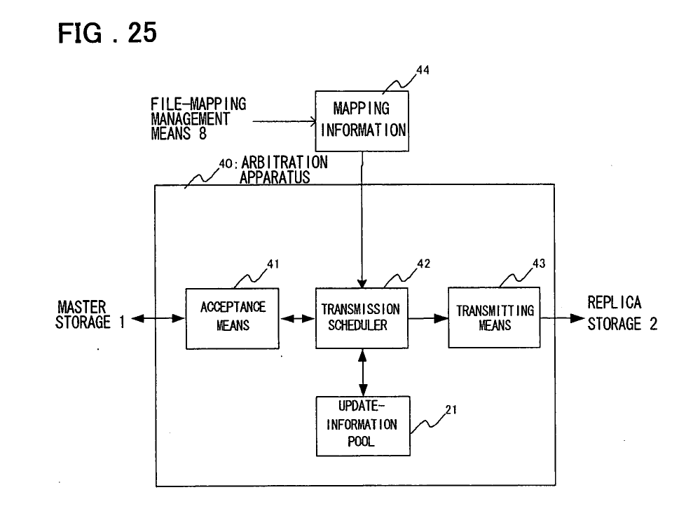

FIG. 25 is a diagram illustrating the configuration of the arbitration apparatus 40 in this embodiment. As shown in FIG. 25, the arbitration apparatus 40 includes acceptance means 41, a transmission scheduler 42, the update-information pool 21 and transmitting means 43. The transmission scheduler 42 refers to mapping information 44 from the file-mapping management means 8.

Upon receiving update information from master storage 1, the acceptance means 41 creates an acceptance ID, which indicates the acceptance sequence, and a temporary storage format.

Next, the acceptance means 41 delivers the created temporary storage format to the transmission scheduler 42.

Next, upon waiting from a command from the transmission scheduler 42 to send back a response, the acceptance means 41 transmits a response to master storage 1, which is the transmission destination of update information.

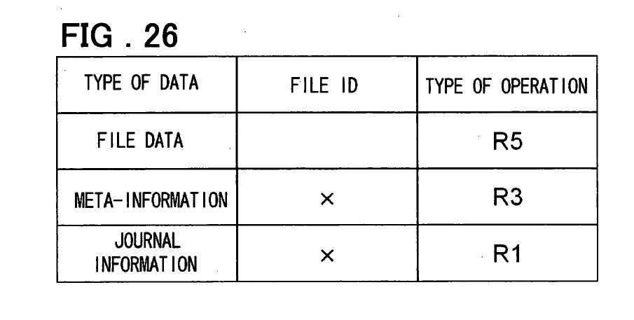

Transmission rules are configured as a table having a plurality of entries, and each entry possesses the following information, as illustrated in FIG. 26:

type of data (file data/meta-information/journal information);

file ID (only in case of file data); and

information indicating type of operation.

It should be so arranged that a value indicating that file ID need not be taken into account is recorded in the file ID. Further, in a case where the transmission rules are evaluated in the order of entry priority and an evaluated temporary storage format is applicable to a plurality of entries, then the operation of the entry having the highest priority is executed.

The following are the types of operations:

(R1) transmit immediately;

(R2) do not transmit until available capacity of update-information pool 21 falls below a threshold value;

(R3) do not transmit for a predetermined period of time following reception;

(R4) transmit upon elapse of a predetermined period of time following reception;

(R5) do not transmit until issuance of an external command;

(R6) do not transmit until a predetermined time arrives; and

(R7) transmit if update information having a higher priority has not accumulated in the update-information pool 21.

With the exception of immediate transmission, there are also cases where a plurality of operations are combined.

A specific example of the setting of priority of transmission rules according to this embodiment will now be described.

Priority 1: send journal information immediately;

Priority 2: send File 1 (journal file of database) immediately;

Priority 3: send meta-information in case of no high priority; and

Priority 4: send other file in case of no high priority.

Since journal information is transferred by such setting of priority, the structure of the file system, i.e., meta-information, can be restored to the latest information.

Further, since the journal file of the database also is transferred immediately and the structure of the file system is the latest structure, the file of the journal can be accessed without difficulty and the database can be restored to the latest state.

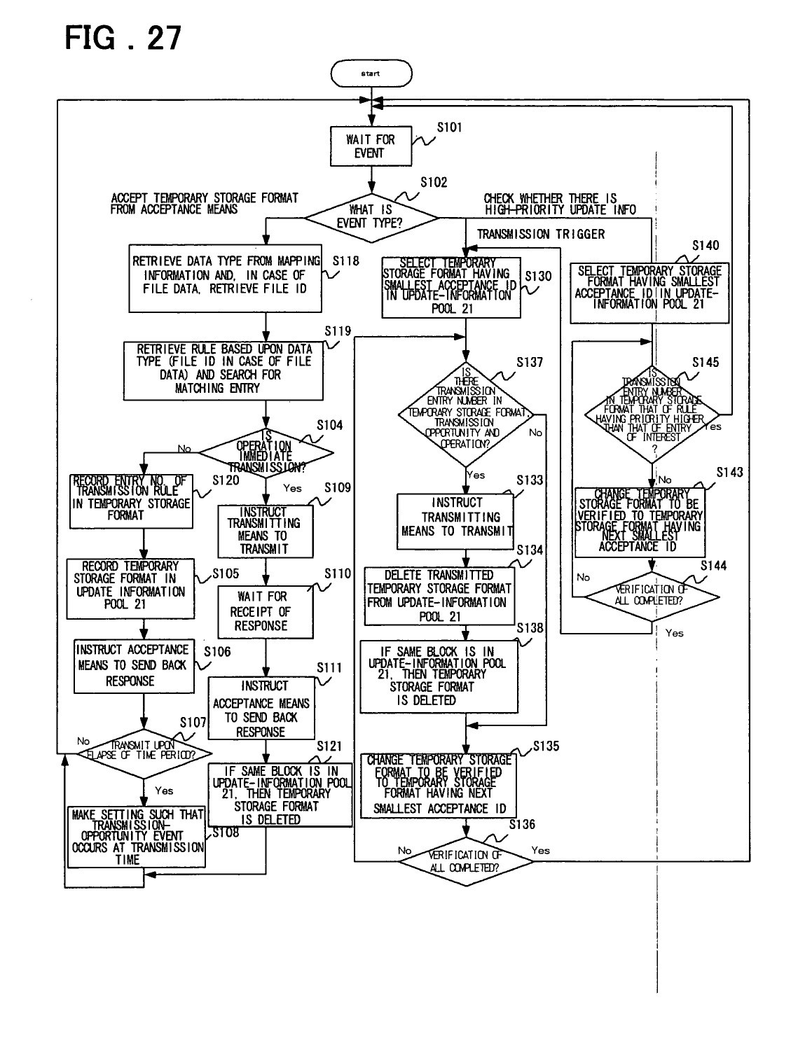

FIG. 27 is a flowchart for describing the operation of the transmission scheduler 42 in this embodiment. In this embodiment, step S103 in FIG. 5 is replaced by a step (step S118) of retrieving data type from mapping information and, if the data type is file data, retrieving the file ID, and a step (step S119) of retrieving a transmission rule and searching for a matching entry based upon the data type (file ID in case of file data).

In a case where the type of operation is not immediate transfer (“NO” branch at step S104), the entry ID (number) of the transmission rule is recorded in the area (see FIG. 9) of the entry ID of the temporary storage format (step S120) and the temporary storage format is recorded in the update-information pool 21 (step S105).

In case of immediate transmission (“YES” branch at step S104), the transmission scheduler instructs the acceptance means 41 to send back a response (step S111) and checks to determine whether the same block is in the update-information pool 21. If the same block is in the update-information pool 21, then the temporary storage format is deleted (step S121).

Further, in FIG. 27, steps S131 and S132 in FIG. 5 are replaced by a step S137 of determining whether there is a transmission entry number in the temporary storage format and an operation that is a transmission trigger.

Furthermore, in FIG. 27 steps S141 and S142 of FIG. 5 are replaced by a step S145 of determining whether the transmission entry number of the entry area of the temporary storage format is that of a rule having a priority higher than that of the target entry. If the transmission entry number of the entry area of the temporary storage format is not that of a rule having a priority higher than that of the target entry, then the temporary storage format to be verified is changed to one for which the acceptance ID is small (step S143).

Since the mapping information 44 in the file-mapping management means 8 is changed at any time, verification is performed whenever update information is accepted (step S118).

It may be so arranged that when the mapping information is changed by the file-mapping management means 8 (when a file is created/when a data block is added to a file/when a file is deleted, etc.), the mapping information is sent to the arbitration apparatus 40. If this arrangement is adopted, there is a reduction in processing load in terms of querying the file-mapping management means 8 for mapping information and the processing performance of the host rises as a result. Further, processing by the arbitration apparatus 40 is speeded up because it is no longer necessary to wait for the querying of the file-mapping management means 8 for mapping information.

Management of the temporary storage formats in the update-information pool 21 is the same as that of the first embodiment.

When a temporary storage format is delivered from the transmission scheduler 42 and transmission is instructed, the transmitting means 43 extracts the destination of update information and the update information and transmits the update information to the destination of the update information. If a response is sent back from the destination to which the update information was transmitted, the transmission scheduler 42 is notified of arrival of the response and processing is terminated.

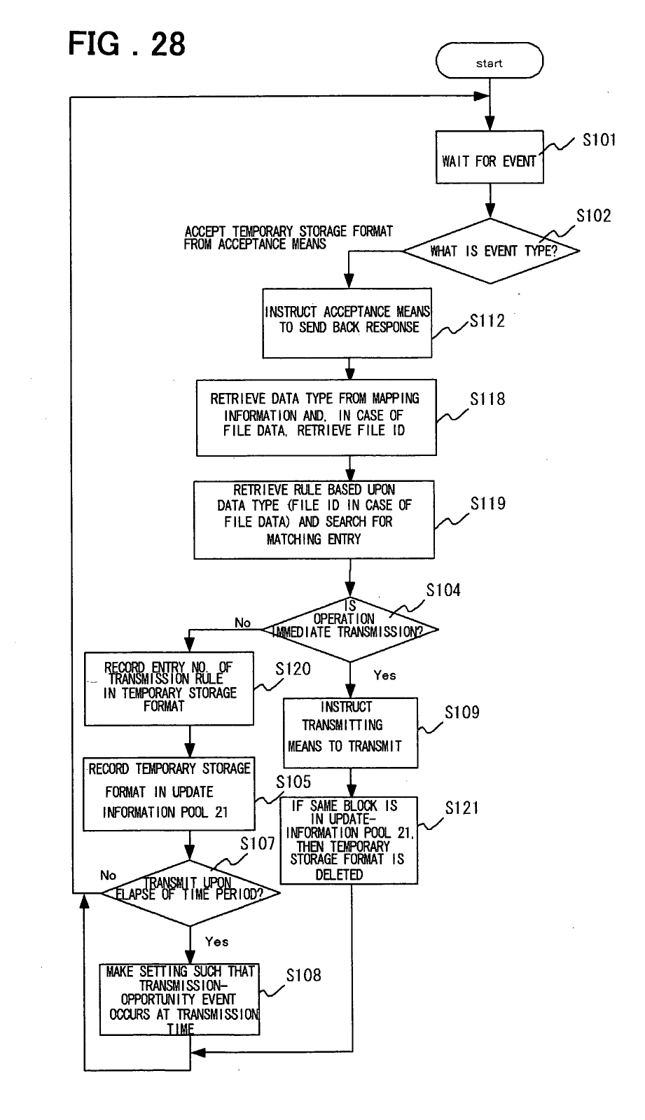

FIG. 28 is a flowchart illustrating another operation of a transmission scheduler 42. Since operation other than that of event in which a temporary storage format is extracted from the acceptance means 41 is the same as that in FIG. 27, this need not be described again.

In FIG. 28, step S103 in FIG. 7 is replaced by the step (step S118) of retrieving data type from mapping information and, if the data type is file data, retrieving the file ID, and a step (step S119) of retrieving a transmission rule and searching for a matching entry based upon the data type (file ID in case of file data).

In a case where the type of operation is not immediate transfer (“NO” branch at step S104), the entry ID (number) of the transmission rule is recorded in the area (see FIG. 9) of the entry ID of the temporary storage format (step S120) and the temporary storage format is recorded in the update-information pool 21 (step S105).

In case of immediate transmission (“YES” branch at step S104), the transmission scheduler 42 instructs the transmitting means 43 to transmit (step S109) and checks to determine whether the same block is in the update-information pool 21. If the same block is in the update-information pool 21, then the temporary storage format is deleted (step S121).

The example illustrated in FIG. 28 is an asynchronous replication operation. Even in a case where immediate transmission is performed, processing for performing a transfer to replica storage has no effect upon master storage.

All update information of a plurality of temporary storage formats corresponding to the same entry of transmission rules is transmitted. However, it may be so arranged that a transition is made to event wait at the stage where some of the update information of a plurality of matching temporary storage formats could be transmitted.

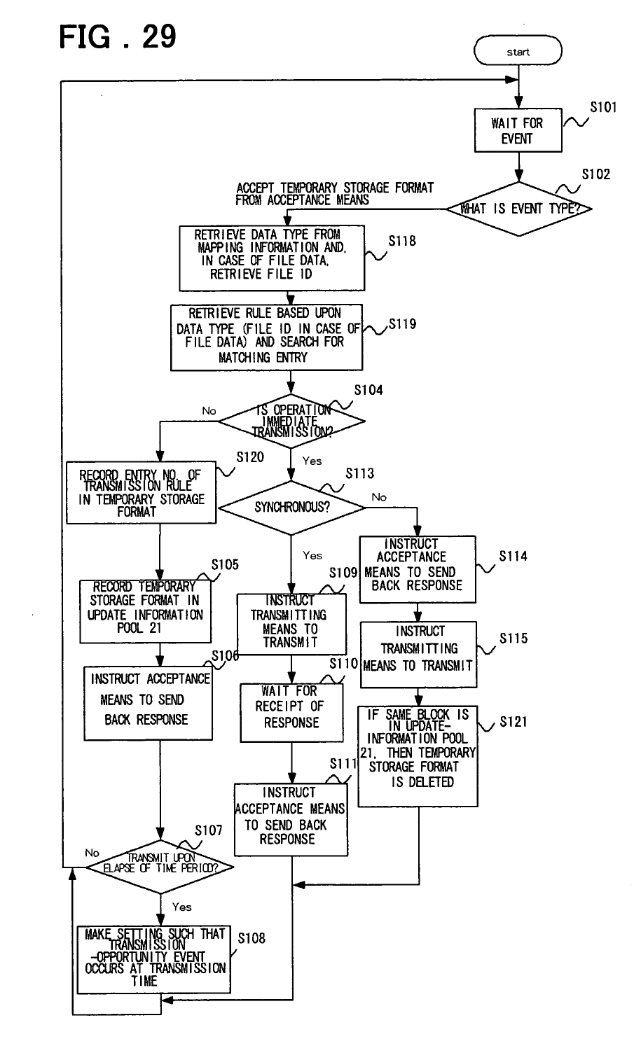

FIG. 29 is a flowchart illustrating a further operation of the transmission scheduler 42. Since operation other than that of event in which a temporary storage format is extracted from the acceptance means 41 is the same as that in FIG. 27, this need not be described again.

In FIG. 29, step S103 in FIG. 8 is replaced by the step (step S118) of retrieving data type from mapping information and, if the data type is file data, retrieving the file ID, and a step (step S119) of retrieving a transmission rule and searching for a matching entry based upon the data type (file ID in case of file data).

In a case where the type of operation is not immediate transfer (“NO” branch at step S104), the entry ID (number) of the transmission rule is recorded in the area (see FIG. 9) of the entry ID of the temporary storage format (step S120) and the temporary storage format is recorded in the update-information pool 21 (step S105).

In case of immediate transmission (“YES” branch at step S104) and asynchronous transmission (“NO” branch at step S113), the transmission scheduler instructs the acceptance means 41 to send back a response (step S114), instructs the transmitting means 43 to transmit (step S115) and checks to determine whether the same block is in the update-information pool 21. If the same block exists in the update-information pool 21, then the temporary storage format is deleted (step S121).

In the example illustrated in FIG. 29, immediate transmission is divided into two types, namely synchronous and asynchronous, by the transmission rules. In this case, it is possible to switch between synchronous replication (transfer of a response from replica storage) and asynchronous replication (response by the acceptance means) depending upon the file or file type. That is, depending upon the file or file type, it is possible to switch between an instance where the influence of replication is not imposed upon processing of master storage (asynchronous replication) and an instance where complete duplication of data is guaranteed (synchronous replication). In other words, how replication is carried out can be changed over appropriately in conformity with the data contained in storage.

In the example of FIG. 29, all of the update information of a plurality of temporary storage formats corresponding to the same entry of transmission rules is transmitted. However, it may be so arranged that a transition is made to event wait at the state where some of the update information could be transmitted. It should be noted that in case of transmission after storage in the update-information pool 21, only asynchronous replication is performed.

The operation of the recovery means 60 in this embodiment will now be described. In a case where master storage 1 can no longer operate, processing is resumed using replica storage 2. The recovery means 60 performs recovery of data in replica storage 2 before processing is resumed. The recovery means 60 reads data out of the replica storage 2 and changes locations of data mismatch in replica storage 2 to a state in which there is no mismatch.

In recovery processing, first the coherency of the file system is restored based upon meta-information and journal information by part of fsck, scandisk or mount processing.

Next, file coherency is restored by a recovery program.

In a database system, the latest state can be restored by applying journal data to table data in order of decreasing age. The file holding the journal of the database is read in and the file holding the table is restored to the latest state (this corresponds to processing referred to as “crash recovery” of a database system).

In this embodiment, a single host is assumed for the sake of simplicity. However, the hosts may be plural in number. Further, in the case of a cluster file system in which a single file system is shared by a plurality of hosts, the file-mapping management means 8 is in a meta-information server. When each host performs file access, the file-mapping management means 8 communicates with the meta-information server and performs a translation between the file address and the address of master storage.

Though the present invention has been described in accordance with the foregoing embodiments, the invention is not limited to these embodiments and it goes without saying that the invention covers various modifications and changes that would be obvious to those skilled in the art within the scope of the claims.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. An arbitration apparatus placed between a storage system of a replication source and a storage system of a replication destination; transfer between the storage system of said replication source and the storage system of said replication destination being performed via said arbitration apparatus, said arbitration apparatus comprising:
acceptance means that receives the update information which has been transferred from the storage system of the replication source;
storing means in which the update information received is temporarily stored;
transmitting means that transmit the update information received to the storage system of the replication destination; and
schedule means that controls scheduling of transmission of the update information received, based upon address information of the update information in storage of said replication source, so as to transmit the update information received immediately or preferentially to the storage system of a replication destination, or to store the update information received in the storing means temporarily and transmit the update information hat has been temporarily stored in the storing means to the storage system of the replication destination on the occurrence of a prescribed event.

2. The apparatus according to claim 1, wherein said schedule means retrieve a transmission rule that decides a sequence of application of the update information in the storage system of said replication destination based upon at least one item of information from among identification information of the update information in storage of said replication source, volume information and block address information within a volume, and exercises control to transmit the update information to the storage system of said replication destination in accordance with the transmission rule retrieved.

3. An arbitration apparatus placed between a storage system of a replication source and a storage system of a replication destination;
transfer between the storage system of said replication source and the storage system of said replication destination being performed via said arbitration apparatus, said arbitration apparatus comprising:
acceptance means that receives update information transmitted from the storage system of said replication source;
a transmission scheduler that controls scheduling of transmission of the update information received by said acceptance means, by referring to a transmission rule that decides a sequence of application of the update information in the storage system of said replication destination; and
transmitting means that receives a transmit command from said transmission scheduler and transmits the update information to the storage system of said replication destination.

4. The apparatus according to claim 3, further comprising:
storing means in which the update information received is temporarily stored;
wherein said transmission scheduler retrieves any transmission rule that is applicable based upon identification information and address information of the update information in storage of said transmission source, and, in accordance with type of operation stipulated by the transmission rule retrieved, exercises control to store the update information in the storing means temporarily and transmit the update information stored temporarily in the storing means on the occurrence of a prescribed event, or to transmit the update information immediately.

5. The apparatus according to claim 3, wherein the storage system of said replication source and the storage system of said replication destination each have a plurality of storages.

6. The apparatus according to claim 3, wherein the transmission rule has the following items as one entry:
storage identification information of the storage system of said replication source;
volume information;
offset information indicating the range of a block in a volume; and
type of transmitting operation of the update information.

7. The apparatus according to claim 3, wherein said acceptance means associates and delivers update information, a storage ID in the storage system of said replication source and an acceptance ID that corresponds to the order in which the update information was received to said transmission scheduler as one set of information.

8. The apparatus according to claim 6, wherein types of transmitting operations of update information include at least one or a combination of a plurality of:
immediate transmission;
control of whether or not to transmit based upon available storage in said storing means;
control of whether or not to transmit update information based upon elapsed time following reception;
control of whether or not to transmit in response to an externally applied command;
control of transmission in accordance with a specified time; and
control of transmission based upon priority.

9. The apparatus according to claim 3, wherein the storage system of the replication source is virtualized, and said apparatus further comprises:
address translation means that makes a translation to a logical address upon acquiring mapping information indicating state of virtualization of the storage system of said replication source;
wherein storage identification information and block number of the storage system of said replication source are calculated from an address virtualized in accordance with the mapping information, and sequence of updating of the data in storage of said replication source of the update information is rationalized based upon the transmission rule.

10. The apparatus according to claim 9, further comprising address translation means for acquiring an address from storage information of the storage system of said replication source and from address information of the update information and converting the address to a logical address based upon the mapping information.

11. The apparatus according to claim 9, wherein said acceptance means extracts address information from the update information, acquires a logical address from said address translation means, converts the address information from the update information to a logical address and delivers the logical address together with an acceptance ID to said transmission scheduler.

12. The apparatus according to claim 11, wherein the storage system of said replication destination stores a logical image of the storage system of said replication source.

13. The apparatus according to claim 3, wherein mapping information is acquired from file-mapping management means that manages mapping of files of the storage system of said replication source.

14. The apparatus according to claim 13, wherein the mapping information includes, in accordance with a file and meta-information, identification information of the file, an address within the file and address information within storage of the storage system of said replication source.

15. The apparatus according to claim 3, wherein in a case where a transmission rule corresponding to the update information that has been transferred from the storage system of said replication source is not indicative of immediate transmission, said transmission scheduler stores the update information in storing means and supplies to said acceptance means a command to send back a response to the storage system of said replication source;
in a case where the transmission rule is indicative of transmission upon elapse of a fixed period of time, said transmission scheduler makes a setting in such a manner that a transmission-trigger event will occur at this time; and
in a case where the transmission rule is indicative of immediate transmission, said transmission scheduler sends said transmitting means a transmit command and, upon receiving a response, sends said acceptance means a command to send back a response to the storage system of said replication source.

16. The apparatus according to claim 3, wherein when a transmission-trigger event occurs, said transmission scheduler extracts the update information, which has been stored in the storing means, in accordance with the acceptance sequence and, if the corresponding transmission rule matches the trigger of transmission, instructs said transmitting means to transmit the update information.

17. The apparatus according to claim 16, wherein said transmission scheduler stores the transmission rule corresponding to the update information in association with the update information so as to eliminate processing for retrieving the transmission rule corresponding to the update information when the transmission-trigger event occurs.

18. The apparatus according to claim 3, wherein if transmission rules corresponding to update information are plural in number, then said transmission controller exercises control so as to execution transmission according to the transmission rule having the highest priority.

19. An information processing system comprising the system of said replication source, the arbitration apparatus set forth in claim 1, and the storage system of said replication destination.

20. The system according to claim 19, further comprising recovery means for recovering the storage system of said replication destination.

21. A replication control method in which transfer between a storage system of a replication source and a storage system of a replication destination is performed via an arbitration apparatus placed between the storage system of the replication source and the storage system of the replication destination, the method comprising:
a step of said arbitration apparatus receiving update information that has been transferred from the storage system of said replication source;
a step of said arbitration apparatus exercising control of the transfer of the update information received, based upon address information of the update information in storage of said replication source, so as to transfer the update information received to the storage system of said replication destination immediately or preferentially, or to store said update information received in storing means temporarily and transmit the update information that has been stored in the storing means to the storage system of a replication destination on the occurrence of a prescribed event.

22. A program for causing a computer to execute the following processing, said computer constituting an arbitration apparatus placed between a storage system of a replication source and a storage system of a replication destination, transfer between the storage system of said replication source and the storage system of said replication destination being performed via said arbitration apparatus:
processing for receiving update information that has been transferred from the storage system of said replication source; and
processing for exercising control of the transfer of the update information received, based upon address information of the update information in storage of said replication source, so as to transfer the update information received to the storage system of said replication destination immediately or preferentially, or to store said update information received in storing means temporarily and transmit the update information hat has been stored in the storing means to the storage system of a replication destination on the occurrence of a prescribed event.
